(19) United States
(12) Patent Application Publication
(10) Pub. No.: US 2026/0246622 A1
(43) Pub. Date: Aug. 20, 2026

(54) ENTITY INTERACTIONS

(71) Applicant: ORIGIN SECURED LTD, Wokingham Berkshire (GB)

(72) Inventors: James Carl BARKER, Wokingham Berkshire (GB); Stuart Edward KENNY, Wokingham Berkshire (GB); Marc Daryl AYRES, Wokingham Berkshire (GB); Steven WINNINGTON, Wokingham Berkshire (GB)

(21) Appl. No.: 19/472,502

(22) PCT Filed: Apr. 5, 2024
(86) PCT No.: PCT/GB2024/050927

§ 371 Date: Oct. 3, 2025

(30) Foreign Application Priority Data
Apr. 6, 2023 (GB) 2305218.6

(51) Int. Cl. H04L 9/08; H04L 9/30; H04L 9/32

(52) U.S. Cl. CPC H04L 9/085; H04L 9/0825; H04L 9/0869; H04L 9/30; H04L 9/3218; H04L 9/3247

(57) ABSTRACT

In an aspect, a method implemented by a computing device associated with an Entity is described. The method includes generating a Seed from which one or more keys for facilitating one or more Interactions between the Entity and one or more other Entities associated with a Community can be derived; splitting the Seed into multiple shares; and transmitting a first share of the Seed to a first storage. The first share is encrypted with a first key, of the one or more keys, associated with a Community.

### FIELD

The disclosure relates to various methods, apparatus, and computer-readable media for facilitating Entity Interactions.

### BACKGROUND

There are multiple challenges for privacy and security in a highly interconnected digital age. Physical assets are increasingly being replaced or otherwise represented by digital assets. Using a blockchain solution alone does not guarantee privacy and security. Digital assets that are represented on a secure blockchain ecosystem may be vulnerable to attack via one or more novel techniques. Attackers are continuously developing new ways to identify vulnerabilities in the crypto ecosystem to attack users and organizations in order to steal digital assets or otherwise carry out malicious activity. For example, crypto wallets where a user does not control their private key but instead cede control to a party that they trust such as a crypto exchange may be vulnerable to attack. However, attacks on such crypto exchanges are increasingly common.

Privacy is also increasingly a concern for practical and regulatory reasons. Users are becoming more aware about how their digital footprint is monitored by third parties. Personal identifiable information (PII) and/or other data for attesting to user identity may be useful for facilitating some web-based functions, this implies a need to transmit such information. When such information is transmitted, there is the chance for PII or other confidential data to be extracted or collated by a third party, whether for malicious reasons or not.

Presently available solutions may not address one or more of these problems and any other problems outlined herein or otherwise inferred.

### SUMMARY

Maintaining or enhancing one or more of privacy, security, integrity, security, flexibility, and/or useability, etc., of a product or service is complex since the product or service may rely on Interactions between one or more Entities such as organizations and one or more users. In general, the more Entities that are involved, the greater the chance for privacy and/or security to be breached. It is therefore difficult for Entities (such as solution providers and their customers) to work together in order to implement a solution that is satisfactory. For example, sometimes a customer may provide their own solution and would prefer to not involve any third parties (since this is a safer choice instead of opening up the solution) when attempting to enhance privacy and/or security of the solution. However, such customers may not have the expertise, time or funds to create an appropriate solution to their needs.

Techniques are described to facilitate certain Entity Interactions.

Certain aspects of the disclosure and their embodiments may provide solutions to one or more of these or other challenges.

In a first aspect, a method implemented by a computing device associated with an Entity, the method comprising: generating a Seed from which one or more keys for facilitating one or more Interactions between the Entity and one or more other Entities associated with a Community can be derived; splitting the Seed into multiple shares; and transmitting a first share of the Seed to a first storage, wherein the first share is encrypted with a first key, of the one or more keys, associated with the Community.

In a second aspect, a method implemented by a computing node is described. The method comprises: receiving a share of a Seed from which one or more keys for facilitating one or more Interactions between a plurality of Entities associated with a Community can be derived; and storing the share in a memory accessible to the computing node. The share is encrypted with a first key, of the one or more keys, associated with the Community.

In a third aspect, a method implemented by a computing device associated with a Community is described. The method comprises: verifying a signature applied to metadata by a new or existing Entity associated with the Community. The signature is based on a key derived from a Seed from which one or more keys for facilitating one or more Interactions between a plurality of Entities associated with the Community can be derived. The method further comprises checking a proof indicative that the new or existing Entity applied the signature.

In a fourth aspect, a method implemented by a computing device associated with an Entity is described. The method comprises generating a Seed; splitting the Seed into multiple shares; and transmitting a first share of the Seed to a first storage. The first share is encrypted with a first key associated with a Community.

In a fifth aspect, a method implemented by a computing node is described. The method comprises receiving a share of a Seed; and storing the share in a memory accessible to the computing node. The share is encrypted.

In a sixth aspect, a method implemented by a computing device associated with a Community is described. The method comprises verifying a signature applied to metadata by a new or existing Entity associated with the Community; and checking a proof indicative that the new or existing Entity applied the signature.

In a seventh aspect, a method implemented by a computing device is described. The method comprises receiving an indication that a share of a public key associated with an Entity is not accessible and/or has been destroyed; and indicating that the Entity is potentially compromised.

In an eighth aspect, a method implemented by a computing device associated with an Entity is described. The method comprises controlling an Interaction between a controlled Entity under control of the Entity and another Entity.

In a ninth aspect, a method implemented by a computing device associated with an Entity is described. The method comprises obtaining a key associated with a Community. The key is configured to facilitate one or more Interactions between the Entity and one or more other Entities associated with the Community.

In a tenth aspect, a method implemented by a computing device associated with an Entity is described. The method comprises generating a signature for data. The signature is combinable with one or more other signatures generated by one or more other Entities.

In an eleventh aspect, a method implemented by a computing device associated with an Entity is described. The method comprises verifying a combined signature generated based on data signed by the Entity and one or more other Entities, wherein the signature generated by the Entity is combinable with one or more other signatures generated by one or more other Entities.

In a twelfth aspect, a computing device or computing node is described. The computer device or computing node comprises a memory; and a processor coupled to the memory. The processor is configured to implement the method of any of the first to eleventh aspects.

In an thirteenth aspect, an apparatus is described. The apparatus comprising means for performing the method of any of the first to eleventh aspects.

In a fourteenth aspect, a non-transitory machine-readable medium is described. The non-transitory machine-readable medium stores instructions which, when implemented by a processor, cause the processor to implement the method of any of the first to eleventh aspects.

In a fifteenth aspect, a computer-readable medium is described. The computer-readable medium stores instructions which, when implemented by a processor, cause the processor to implement the method of any of the first to eleventh aspects.

The summary is not intended to be used in isolation to determine the scope of the claimed subject matter, nor identify key or essential features of the claimed subject matter. The disclosed subject matter can be understood with reference to any part of this entire disclosure, including one or more parts of the description, one or more claims, and/or one or more drawings. The foregoing, along with other described subject matter, will be described in more detail below in the following description, claims, and accompanying drawings.

### BRIEF DESCRIPTION OF THE DRAWINGS

Exemplary embodiments of the disclosure will now be described, by way of example only, with reference to the following drawings, in which:

FIG. 1 a schematic diagram illustrating an example blockchain ecosystem;

FIG. 2 is schematic diagram of a system in which one or more embodiments may be implemented;

FIGS. 3A-3C include different parts of a schematic diagram depicting an implementation of a key hierarchy used in one or more embodiments described herein;

FIG. 4 is a schematic diagram depicting certain Interactions in a Community according to one or more embodiments described herein;

FIGS. 5A-5E refer to parts of a schematic diagram depicting a system for implementing various techniques of this disclosure;

FIG. 6 is a schematic diagram depicting a system for implementing assertions and endorsements according to one or more embodiments described herein;

FIG. 7 is a schematic diagram depicting different types of revisions that can be used according to one or more embodiments described herein;

FIG. 8 is a schematic diagram of a type of assertion that can be used according to one or more embodiments described herein;

FIG. 9 is a schematic diagram of a type of assertion that can be used according to one or more embodiments described herein;

FIGS. 10A-10C depict a sequence of verifications that can be performed as new Entities interact with each other according to one or more embodiments described herein.

FIG. 11 is a flowchart of a method according to an aspect;

FIG. 12 is a flowchart of a method according to an aspect;

FIG. 13 is a flowchart of a method according to an aspect;

FIG. 14 is a flowchart of a method according to an aspect;

FIG. 15 is a flowchart of a method according to an aspect;

FIG. 16 is a flowchart of a method according to an aspect;

FIG. 17 is a flowchart of a method according to an aspect;

FIG. 18 is a flowchart of a method according to an aspect;

FIG. 19 is a schematic drawing of a computer-readable medium for implementing various embodiments described herein; and

FIG. 20 is a schematic drawing of apparatus for implementing various embodiments described herein.

### DETAILED DESCRIPTION

One or more aspects or embodiments referred to herein will now be described more fully with reference to the accompanying drawings. Aspects and embodiments are provided by way of example to convey the scope of the subject matter to those skilled in the art.

The disclosure relates to various methods, apparatus, and computer-readable media for facilitating Entity Interactions. Examples of Entity Interactions are discussed below, along with various definitions, to help explain the subject matter of this disclosure. One or more techniques described herein leverage technologies that can be used in certain blockchain ecosystems. However, it should be understood that one or more techniques of this disclosure are also applicable to non-blockchain uses cases and do not need to use any part of a blockchain in order to facilitate the stated functionality. In other similar words, whilst blockchain may be described in relation to certain scenarios, one or more techniques of this disclosure do not rely on a blockchain ecosystem. Thus, one or more techniques of this disclosure may have utility in various scenarios including off-chain and on-chain (including private and public blockchains) scenarios. Further, one or more techniques of this disclosure can be implemented without relying on a blockchain ecosystem in order to implement the stated functionality. Thus, one or more techniques of this disclosure can be implemented irrespective of the use case since they do not rely on a specific blockchain architecture in order to facilitate the stated functionality.

Following on from the above discussion, it is apparent that blockchain ecosystems hold considerable potential. However, use of blockchain does not necessarily imply that a desired level of security and privacy, among other properties, is provided. For example, blockchain may help to facilitate certain use cases such as providing a cryptographically secure mechanism to transfer a digital asset between users, verifying such transfers, etc. However, existing techniques that apply certain principles of blockchain (such as cryptographic mechanisms) to other use cases can experience limitations that restrict wider adoption of blockchain technology and/or inhibit the creation of innovative products or services. In other similar words, blockchain ecosystems do not in, in themselves, have functionality to support a wide range of use cases. An example blockchain ecosystem is described below.

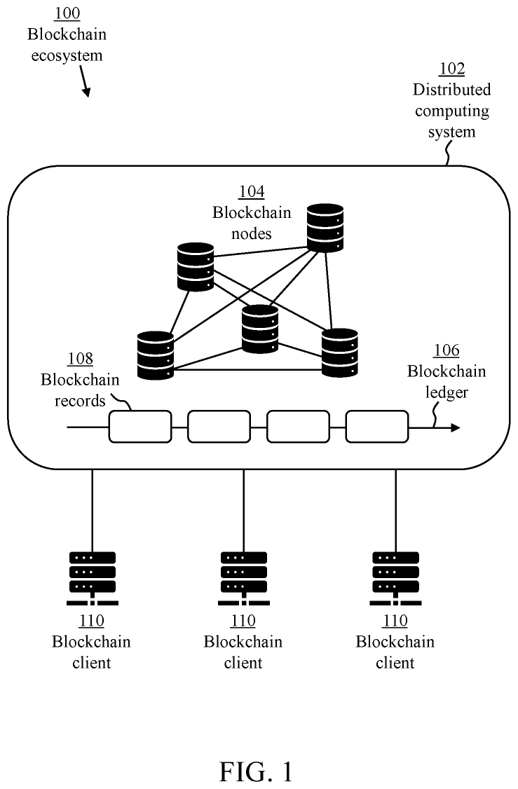

FIG. 1 is a schematic diagram illustrating an example blockchain ecosystem 100 that may, in some cases, be used in conjunction with or as part of one or more aspects or embodiments of this disclosure. The blockchain ecosystem 100 could be based on the Ethereum ecosystem or another type of blockchain ecosystem.

The blockchain ecosystem 100 comprises a distributed computing system 102. The distributed computing system 102 comprises a set of blockchain nodes 104 configured to maintain a blockchain ledger 106 (i.e., the blockchain), which may evolve over time in response to transactions submitted to the blockchain ecosystem 100. A set of blockchain records 108 are recorded on the blockchain ledger 106 where each record 108 (which could also be referred to as a block) comprises data representative of a transaction or a set of transactions. Each blockchain record 108 may be cryptographically linked to the other blockchain records 108. For example, a transaction may be submitted to the blockchain by one of a set of blockchain clients 110 connected to the distributed computing system 102 at a certain time. Upon successful verification of the submitted transaction (or a set of submitted transactions over a period of time), the blockchain record 108 is recorded on the ledger 106.

The blockchain record 108 may comprise a hash (e.g., generated by a cryptographic hash function such as Keccak-256 or another appropriate function) derived from the previously recorded blockchain record 108. The blockchain record 108 may further comprise data such as a cryptocurrency balance, a hash of an opcode associated with the executed smart contract, a nonce, a timestamp, etc. Since each blockchain record 108 comprises a hash derived from the previous blockchain record 108, each blockchain record 108 is cryptographically linked together. Further, each blockchain record 108 may comprise a Merkle tree root hash derived from a set of hashes derived from the transactions recorded in the blockchain record 108. In the event of a discrepancy of the Merkle tree root hash between different versions of the blockchain ledger 106 held by the blockchain nodes 104, this discrepancy can be detected and suitably addressed.

As already noted, maintaining or enhancing one or more of privacy, security, integrity, security, flexibility, and/or useability, etc., of a product or service is complex since the product or service may rely on Interactions between one or more Entities such as organizations, one or more users, etc. In general, the more Entities that are involved, the greater the chance for privacy and/or security to be breached. It is therefore difficult for Entities (such as solution providers and their customers) to work together in order to implement a solution that is satisfactory. For example, sometimes a customer may provide their own solution and would prefer to not involve any third parties (since this is a safer choice instead of opening up the solution) when attempting to enhance privacy and/or security of the solution. However, such customers may not have the expertise, time or funds to create an appropriate solution to their needs.

Certain aspects of the disclosure and their embodiments may provide solutions to one or more of these or other challenges.

Techniques described herein may facilitate Entity Interactions in a broad range of scenarios. The techniques may be applicable for many use cases, including use cases not explicitly described by this disclosure. Entities and Interactions are both terms that are defined below. Further definitions will be provided as and when they arise in the discussion given below.

As used herein, the term ‘Entity’ is a term used to describe a comprehensive system that includes everything within the universe, including living organisms, inanimate objects, digital avatars, artificial intelligence, or any being.

This ‘Entity’ is a distinct unit that holds relevance in a particular context. It can be a concrete or abstract thing that exists, can be identified uniquely, and can create interactions. Wherein the Entity comprises one or more of, but not exclusively:

‘Person’: An individual human being.

‘Asset’: A ‘Physical Asset’or a ‘Digital Asset’, such as described below.

‘Physical Asset’: Tangible items of value such as, but not limited to, property, vehicles, or luxury items.

‘Business’: An organization or company engaged in commercial, industrial, or professional activities.

‘Community’: A group of individuals who share common values, interests, or goals.

‘Digital Asset’: Non-tangible items of value that exist in digital form, such as, but not limited to data, NFTs (Non-Fungible Tokens), SFTs (Semi-Fungible Tokens), or Metadata/JSON.

‘AI’: Artificial Intelligence, which refers to systems or machines that mimic human intelligence to perform tasks, and may be able to iteratively improve themselves based on the information they collect.

‘Event’: An organized activity such as a gig, conference, or sporting event.

An Entity may be considered to be ‘controlling’ or ‘controlled’, depending on the context. For example, a person may be a controlling Entity of something such as an Asset owned or controlled by that person. Such an Asset in this context is an example of a ‘controlled Entity’. A person or an AI are examples of a ‘user’ or ‘member’. Any reference herein to a user or member may be considered to refer to any other appropriate type of Entity, where allowed by the context of the discussion.

Thus, the term ‘Entity’ and the plural form ‘Entities’ are to be construed broadly in line with the above and any further discussion below, and are not limited to the specifically listed Entities.

As used herein, an ‘Interaction’ refers to any action, communication, transaction, or exchange that occurs between individual Entities or Entities within the digitally-enabled or physical platform, system, or Community environment. An Interaction may include a wide range of activities such as accessing and using applications, engaging in dialogue or collaboration among users, initiating and completing transactions, sharing or exchanging information, services, or goods, and/or any other form of participative engagement facilitated by the Community's infrastructure. Interactions are governed by the established protocols, standards, and security measures, ensuring they are conducted in a secure, authenticated, and efficient manner. Details of how certain Interactions are governed are the subject of one or more aspects or embodiments of this disclosure. An example purpose of Interactions is to foster a vibrant ecosystem of exchange, collaboration, and innovation, enhancing the value and utility of the Community for all participating Entities. Through leveraging technologies like blockchain, digital signatures, and encryption, the Community may ensure the integrity, authenticity, and, where applicable, confidentiality of these interactions, thereby cultivating a trusted environment for Entities to operate and engage with each other.

As used herein, ‘Live Data,’ also known as real-time data, refers to information that is delivered immediately after collection from an Interaction between Entities. There is no practical delay in the timeliness of the information provided. The Live Data may be streamed continuously through the internet due to constant updates from various Entities. This data may be processed and analyzed immediately upon receipt for tasks that may include real-time decision-making, live reporting, and instant alerting systems.

As used herein, a ‘Community’ refers to a digitally-enabled or physical platform, system, or environment that serves as a central hub or nexus point for the facilitation, authentication, and notarization of interactions and transactions among a diverse set of Entities, including but not limited to applications (software, tools, platforms), individuals (users, participants), organizations (corporations, institutions, associations, government departments, non-profits, etc.), and a community of Communities. This Community framework is designed to enable secure, verified, and/or efficient exchanges or collaborations, leveraging technologies related to blockchain such as digital signatures and encryption techniques to ensure the integrity, authenticity, and, where applicable, confidentiality of the Interactions. An example function of this Community is to foster a trusted ecosystem where these Entities can interact, transact, or exchange information, services, or goods under a common set of rules, protocols, or standards, thereby facilitating a seamless, interoperable, and secure environment for digital or physical engagements. Another example of the Community framework provided by techniques according to this disclosure includes facilitating Interactions between two or more Entities associated with the Community. For example, a first Entity associated with a Community could be an individual or an organization such as a business. A second Entity associated with the Community could be another individual or another organization such as a business. Thus, in an example, a Community could be formed to facilitate Interactions between two or more individuals. In another example, a Community could be formed to facilitate Interactions between one or more individuals and one or more organizations (e.g., an individual could interact with a business). In another example, a Community could be formed to facilitate Interactions between two or more organizations (e.g., two or more businesses could interact with each other). These are given as examples only, and many other types, numbers, and combinations of Entities could interact with each other as part of a Community.

In some cases, an Entity may be considered to be represented by or associated with one or more computing nodes or computing devices. Such a computing node or computing device may be local or remote to an interface (e.g., user interface) through which an Entity (e.g., individual, organization, etc.) associated with the Community causes Interactions to be performed with one or more other Entities (e.g., another individual, organization, etc.) associated with the Community. These other Entities may also be represented by or associated with one or more computing nodes or computing devices. Thus, at a high level, techniques described here may facilitate an Entity (e.g., an individual, organization, etc.) associated with a Community to perform one or more Interactions with respect to one or more other Entities associated with the Community. At a lower level, such Entities may be associated with or may comprise one or more computing nodes or computing devices that performing data processing and/or transmit/receive signals to/from other nodes/computing devices. One or more interfaces (e.g., a user interface, an application programming interface (API), etc.) may be provided to enable an Entity to interact with (at the high level) one or more other Entities. Such Interactions may involve one or more data communications between the Entities (represented at the lower level by computing nodes and/or computing devices) that correspond to or represent the Interactions between the Entities.

For example, a Community may group a set of Interactions that all have a common purpose. The Community may form a nexus point of notarization or verification for that common purpose. In an example, if the Community is an Application, for everything under that Application, the Community may represent a notary for a common purpose of all the Interactions that are then done under the auspices of that Community.

As used herein, an ‘Asset’ refers to any digital or physical item, resource, or property (e.g., a type of Entity such as a controlled Entity) that may hold value within a Community. An Asset may encompass a broad spectrum of Entities including, but not limited to, digital currencies, tokens, intellectual property and intellectual property rights (such as inventions, patents, trademarks, designs, copyrighted work, creative works, trade secrets, knowhow, etc.), contracts, data, software, tools, and physical items represented in digital form. Assets in this framework may be characterized by their ability to be owned, transferred, shared, or otherwise managed through digital means, facilitated by the Community's infrastructure. Utilizing Origin Handle technology (as described below), Entities and Communities can ensure the secure, verified, and efficient handling of Assets, maintaining their integrity, authenticity, and confidentiality as required. Assets within this ecosystem can be leveraged for a variety of purposes, such as transactions, collaborations, investments, or as part of the exchange of goods and services, potentially making them central to the interactions and value exchange within the Community. In some cases, an ‘Asset’ may be a type of Entity which may be referred to herein as a ‘controlled Entity’.

As used herein, a ‘Handle’ refers to a unique identifier or digital Alias used by an individual or Entity within a ‘Community’ to facilitate identification, interaction, and/or communication. The Handle may be referred to herein as an ‘Origin Handle’. The term ‘Origin’ is non limiting and may be used to indicate that an Entity with a Handle has a socially-provable Origin to allow that Entity to interact as part of/in association with a Community. This identifier may be distinctively chosen by the user or automatically assigned by the system, serving as a representation or virtual identity in the digital ecosystem. Handles as described herein are used for enabling secure, efficient, and/or personalized interactions within the community, allowing users to engage in transactions, collaborations, and/or communications while maintaining a level of privacy or anonymity if desired. Additionally, a Handle may be linked to an Entity's (e.g., user's) digital identity, credentials, and access rights within the community, ensuring that interactions and transactions are securely managed and authenticated according to the Community's protocols and the Entity's (e.g., user's) role or authorization level.

As used herein, an ‘Alias’ is a pseudonym, handle, or identifier used by an Entity—4-in place of its real name or identifier. This Alias can be used to interact, transact, or communicate in various contexts while preserving the Entity's privacy and security. An Alias may act like a virtual mask, allowing the Entity to engage in activities without revealing its actual identity, thereby serving as a mechanism for privacy protection and firewalling. The Alias can create modified Profiles from the original Origin Handle, thereby creating a unique identifier that may allow for adjusted public or private profile settings for the Alias Entity to use when Interacting with other Entities.

As used herein, the term “Origin Standard” (OS) may be used to denote that a described solution uses or implements one or more techniques discussed herein. Thus, when referring to OS, this may refer to the functionality provided by one or more embodiments described herein. The OS has solved one or more issues of Digital Interactions related to interoperability of Digital Identity, Provenance, Social Proof and Security of Assets by underpinning all technology as one standard. The OS may become a common standard for the aforementioned interoperability subjects within Blockchain, Web 3.0, Web X and the Metaverse. Within this disclosure, Blockchain (Private or Public), Web X (Covering Web 2.0, 3.0, 4.0, 5.0 and any others in the future), Metaverse (Meta owned or some other version of alternative reality) shall be collectively referred to as Digital Realms.

The present disclosure is based on extensively researched and analyzed existing Digital Realms protocols, networks and applications. One of the identified needs from this research is to ensure that a user's digital assets are safeguarded within a Digital Realm. By introducing an improved user experience and improved security procedures, one or more techniques described herein (e.g., based on the OS) may unlock the door to a much broader audience, meaning more widespread use and applicability of solutions for improving privacy, security, integrity, security, flexibility, and/or useability, etc., of a product or service.

One or more techniques described herein (e.g., based on the OS) may represent an innovative solution to reduce or eliminate fraud using a proprietary system and code. Multiple use case scenarios have been identified, all with significant benefits to Entities and Communities such as users and businesses. One or more techniques described herein may be implemented in such a way that the associated product or service can be designed with the customer experience (CX), the user experience (UX), and/or the user interface (UI) in mind. In a use case, the techniques described herein have been tested and confirmed to work to enable collaborate (between Entities such as users) on the creation of securing (e.g., involving various types of Interactions) an Entity such as a digital asset.

The process (e.g., security process) implemented by one or more techniques described herein may allow users to request verification of an identity without jeopardizing their data security. Partner companies may perform checks and assign confirmation to a unique Handle associated with a user (such a Handle may be referred to herein as an Origin Handle). The identity of that individual may be secured in accordance with one or more aspects or embodiments described herein. However, there may be scenarios where traits can be accessed using professional features of the OS. Partner companies may use assigned Origin Handles for confirmation, creating a signed end-to-end encrypted process for identity verification.

One or more techniques described herein may provide Entities such as users with a universal profile that separates the public and private data, to share with potential partners. As an example, a user can enable their Solicitor to have access to all of their personal information in a completely secured environment whilst restricting their favorite football team to some very basic and generic information. One or more techniques described herein may implement technology that facilitates improved credit checks, Anti Money Laundering (AML) and Know Your Customer (KYC), among other concepts. A service provider implementing or facilitating one or more techniques described herein may be able to remain completely decentralized so that the service provider does not need to have access to any sensitive data.

One or more techniques described herein may facilitate the creation of a practical and robust zero-knowledge proof system that has not yet been realized in the art.

An Origin Handle may provide the intelligence behind any data collected by a service provider for providing the OS. Users can decide what information they are willing to share with enterprise businesses, who can make use of such information accordingly. A service provider for providing the OS can work with clients to enable them to build their own Communities, social proof and loyalty reward systems. The OS may provide the ability for existing companies to retain and expand their established reputations into Web X.0.

A service provider for OS may take a number of steps to ensure the security of the user data.

Such a service provider may ensure best efforts are made to avoid storing any extraneous Personally Identifiable Information (PII) such as card numbers, which are only be stored on the merchant system.

In certain embodiments described herein, PII data may be kept separate from normal data and mapped via a unique identifier (ID), if the user exercises the right to be forgotten, this mapping is deleted, and the data scrambled.

A service provider for providing the OS may be expected to use industry best practices for cloud security and securing data.

Techniques described herein may help a service provider to meet such service expectations.

One or more techniques described herein may be considered to implement a backbone solution in order to facilitate various functions of the OS, which include Endorsement, collaboration and authentication, all of which are discussed in more detail below.

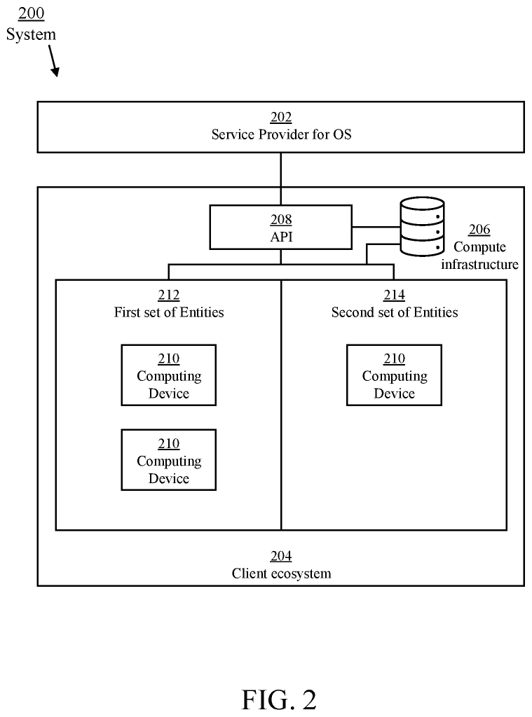

FIG. 2 is schematic diagram of a system 200 in which one or more embodiments may be implemented. The system 200 is an example implementation and other implementations (i.e., architectures) are possible within the scope of the disclosure.

The system 200 comprises a service provider for OS 202 and a client ecosystem 204. The client may be a client of the service provider in some implementations, although in other implementations there may be no Interaction with the service provider. The client ecosystem 204 comprises compute infrastructure 206 (such as one or more processing nodes), an Application Programming Interface (API) 208 and a set of computing devices 210 (e.g., each computing device 210 associated with a user or member of a Community such as an organization). As depicted by FIG. 2, there are first set of Entities 212 (e.g., users or members that may be socially proven by other Entities associated with the community such as by being endorsed by other members associated with a Community) and a second set of Entities 214 (e.g., users or members that have not yet been socially proven by other Entities associated with the community). As discussed previously, a Community may be associated with one or more Entities, which may include controlling and/or controlled Entities. Other types of Entities may be associated with the Community such as controlled Entities. The API 208 is accessible to the set of computing devices 210 and the compute infrastructure 206, and facilitates the implementation of one or more embodiments described herein by the computing devices 210 and/or the compute infrastructure 206.

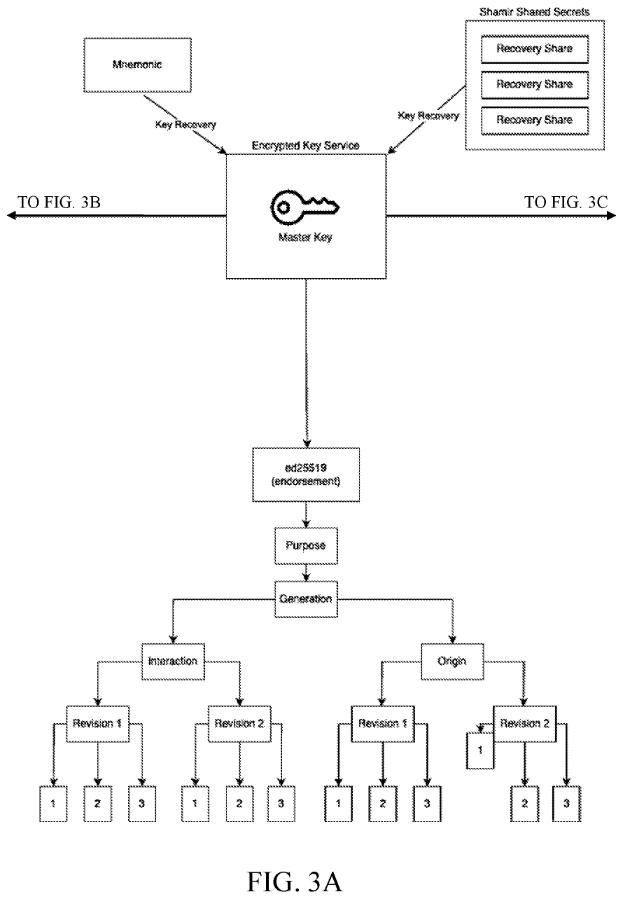

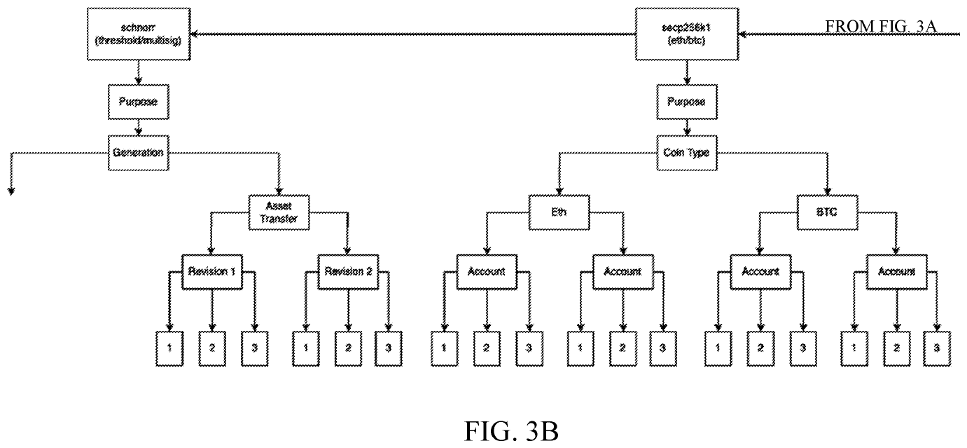

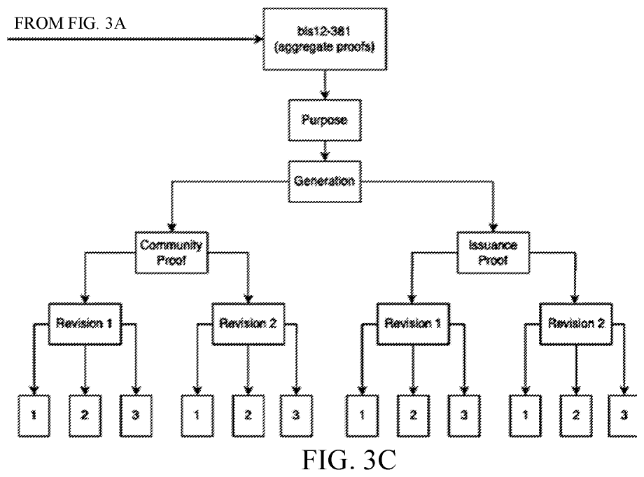

FIGS. 3A-3C include different parts of a schematic diagram depicting an implementation of a key hierarchy used in to one or more embodiments described herein.

Each Entity (e.g., a user or a project associated with a Community) has an associated master key (which may also be referred to herein as a Seed or master Seed). The Seed is generated based on a mnemonic and shares of the Seed. The Seed may be considered to be a spawnable key. The shares of the Seed are stored in trusted storage. Each share is stored in a separate storage such that no two shares are stored in the same logical memory. For example, the shares may be distributed throughout some compute infrastructure such as depicted by FIG. 2. An encryption service is enabled based on the master key, which is used to derive one or more keys deterministically based on the master key. Such keys may be used for different purposes. Each key may be socially proven (e.g., socially endorsed) such that if an Entity signs some data with such a key, a social-based proof mechanism exists to confirm that one or more other Entities associated with the Community trusts and/or verifies that it was indeed the Entity that signed the data, and that the Entity is still socially proven. The keys may be considered to be throwaway or single use or otherwise restricted use, meaning that the system can be confident that the same key cannot be used for a different purpose, which may enhance the security of the system.

FIG. 3 depicts some of the different possible purposes of the keys derived from the master key. In one branch depicted by FIG. 3A, an endorsement key is to facilitate for the purpose of generating a project or an Origin. In another branch depicted by FIG. 3C, a proof key (e.g., aggregate proof key) is to generate a community proof (e.g., for verifying a signature generated within the Community) or an issuance proof key. In another branch depicted by FIG. 3B, a key for use in blockchain operations may be derived. In another branch, a key splitting scheme may be based on a key derived from the master key (e.g., to facilitate asset tracking or transfer). In each case, one or more revisions of the data, project, etc., may be signed using the key dedicated to the particular purpose. Thus, each key derived from the master key is intended for a specific purpose (e.g., a specific type of Interaction) associated with the Community. Security is maintained because no key is reused for signing data associated with different purposes. Instead, a key that has been deterministically derived according to the hierarchy for a specific purpose associated with the Community can be used for signing for only that specific purpose.

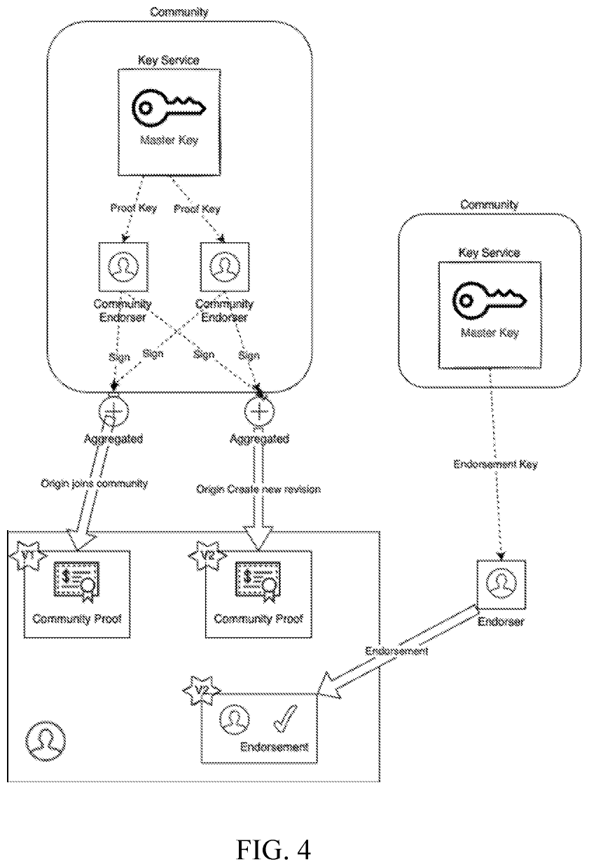

FIG. 4 is a schematic diagram depicting certain Interactions in a Community according to one or more embodiments described herein. An Entity (e.g., a user) in or wishing to join a Community may have access to a master key, which is used to derive a proof key. One or more Community Entities (e.g., other users, which may be referred to herein as ‘endorsers’) may sign and/or countersign a message comprising the proof key, to indicate they endorse the Entity (user). The output is an aggregated signature, indicating Endorsement of the Entity (user). Thus, an Origin (associated with the user) may join the Community since the aggregation of the signatures provides Community-verifiable proof that the Entity (user) can be associated with the Community and is approved. When more than one Community Entity endorses the proof, this may generate a revision to the community proof. Similar, a revocation of Endorsement by one or more Entities may cause the community proof to be revised (e.g., from v1, to v2, etc.). In some cases, a third party Entity may use an endorsement key derived from their master key in order to (e.g., further) endorse the Entity (user).

The OS includes several concepts that can be considered to be under the heading of ‘Interactions’. Interactions may include concepts such as endorsements, collaboration, and authentication, as discussed below. Thus, any reference to such concepts may be considered to generally refer to a type of Interaction. The concepts described below are illustrative of possible functionality enabled by the subject matter described herein, and are not limiting to the scope of the subject matter of the disclosure. Any one or more of these concepts may form part of, be combined in part or in whole with, or used in conjunction with any of the aspects or embodiments described herein.

### Endorsements

Under the endorsement concept, a method may be implemented for enabling endorsements and assertions against known or unknown Entities.

As already noted, an Entity is a term that could be used to describe a comprehensive system that includes everything within the universe, including living organisms, inanimate objects, digital avatars, artificial intelligence or any being.

A request can be received by or sent to any Entity.

Either the initiator/requester Entity or receiver Entity can be known or unknown to each other. It shall be understood that any Community may be associated with two or more Entities. Therefore, any reference herein to scenarios involving two Entities shall be understood to be non-limiting and can extended to scenarios involving more than two Entities.

The request can be made to endorse an Entity as anything that the requester Entity decides to be appropriate. The receiver Entity can make the decision as to whether to accept the request and sign the endorsement, creating a 2-way confirmation signature on the endorsement.

Any Entity can decide to revoke the endorsement at any point in the future and the endorsement will be revoked at the discretion of one party (Entity) at the point of signature revocation.

The following examples demonstrate how the system may be implemented and applied in different contexts.

### Collaboration

An OS Collaboration is an example of a project management tool for WebX.0, amongst many other possible purposes. Such a collaboration may be used to organize and streamline the creation of a digital asset between multiple collaborators (i.e., Entities associated with a Community). This can include but is not limited to contract agreements, creating communities, minting digital NFTs, assigning physical items and much more. Collaboration may be considered to be an element of the OS process for managing projects.

In OS, each project is composed of a number (e.g., two or more) of collaborators who are assigned a number of signatures to contribute to the smart contract metadata. Signatures can be assigned to individual members or groups to ensure that everyone involved has clear expectations and access to the same signature requirements of SFTs or NFTs.

Some projects may require people outside of a network of collaborators. Guests can be invited to join individual projects as additional stakeholders without giving them full access to an entire portfolio.

### Authentication

The OS Handle Endorsements and Collaboration concepts can enable monitor tracing of any Entity such as represented by a record that is stored in an appropriate location such as on-chain, off-chain, etc. Each OS Handle can be linked to any crypto wallet.

The described technology can split the Seed of a Hierarchical Deterministic (HD) wallets. This means that any project collaboration can have one ore more keys issued to the various Entities involved both on a public and private level. This approach may enable multiple (e.g., two or more) Entities to assert authority of any physical asset that a public key and a payload is assigned to. Such a payload may comprise data indicative of one or more of: an identity of an Entity associated with a Community, an identity of the Community, information about the physical asset such as tracking and/or status information (e.g., sender address, recipient address, proof of when and/or where the physical asset has been scanned, or any other useful information for tracking), and/or any other useful information such as a link (e.g., a uniform resource locator) to the public key and/or a link to otherwise facilitate verification of and/or update a status of the physical asset. Any other appropriate information may be included in the payload.

It is also possible to use one or more Radio Frequency Identification (RFID) tags to assign parts of threshold public keys and payloads (as described above) to individual parts of any physical item. This means item tampering is completely identifiable and may ensure the traceability of any asset along any supply chain.

An example of the application of this technology to tracking the bottles of wine through the supply chain.

Cryptographic keys may be split at the Origin associated with the winery. Associated private keys owned by the project collaboration owners may be shared with key stakeholders (e.g., the Winemaker and Winery).

A physical cryptographic key (e.g., a public key) and a payload may be assigned to one or more RFID tags and attached to the physical item (e.g., embedded on seal of the bottle of wine, or otherwise physically implemented and attached).

RFID tags can be scanned at any point and if the seal is broken the key is automatically destroyed, thereby indicating to the relevant stakeholder(s) that the bottle has been compromised.

### Additional Explanation

Master keys (more accurately master Seed) may be generated from a mnemonic (either user supplied or generated for the user) and split into multiple shares using a technique such as Shamir's Shared Secrets. Each share of the Seed is kept separately and encrypted with a different key e.g., a community storage key.

The mnemonic, i.e., a Seed Phrase also known as a Mnemonic Phrase, is a series of words generated by an Origin Handle during its setup. This phrase serves as a backup mechanism for an Origin Handle in the same way as a cryptocurrency wallet's private keys, enabling the owner to recover their Origin Handles in the same was a user can recover their cryptocurrency holdings in case the wallet is lost, damaged, or otherwise inaccessible. The seed phrase is derived from a cryptographic algorithm based on a predetermined word list. The security and confidentiality of the seed phrase are paramount, as anyone with access to it can potentially gain control over the wallet's funds. For this reason, users are advised to store their seed phrase in a secure and private manner, avoiding digital storage methods that could be compromised. The seed phrase is a highly relevant component of wallet security within the blockchain ecosystem, offering a user-friendly and secure method of key management and recovery.

This master Seed is used to deterministically derive private/public keys for different scenarios where each one of the keys is used contextually. For example, each Origin revision gets a proving key via a derivation path. When endorsing a project, a new key pair is issued for the project and the proving key is used to prove the issuance of this key to be valid with the context of the project (a commitment is made from details about the project). See hierarchy of FIG. 3 for more details about key derivation.

Communities may act as a certificate authority where each Community has a set of community endorsers made up from a set of Origins. These Origins combine together to create a Boneh-Lynn-Shacham (BLS) signature to act as an initial proving signature for an Origin joining a Community or a community endorsement.

Public keys may be shared with the item or Origin that has been endorsed so the signature can be verified. The Origin related to public key is also within the signature metadata which can then be used to check the key's issuance proof against the Origin issuance key.

Fully private data would hopefully not be on the system to begin with as one would try to use zero knowledge proofs where appropriate. That said, a user may want some endorsements to be private or only available to certain other parties. These hidden assertions do not appear when data about that particular Handle is requested, and such data requires a proof of access to be able to be retrieved. Thus, the presentation of the Origin can be different to parties who have been given different levels of access (e.g., a different status within the Community). Private/Hidden endorsements may be encrypted and may require proof of access to unlock them.

### Endorsement

‘Endorsement’ refers to a formal acknowledgment, approval, or support of an Asset, Interaction, or Entity within the ecosystem. This acknowledgment is typically made through a digital signature or a similar cryptographic mechanism that verifies the endorser's identity and their authority to provide such endorsement. An endorsement can serve multiple purposes, such as:

Verifying the authenticity and integrity of a digital asset or transaction.

Assertions and statements about an Entity, aspects of the entity or Interaction between Entities.

Confirming the credibility or trustworthiness of entities within the Community, including individuals, organizations, or applications.

Authorizing or validating a transaction, agreement, or interaction, thereby facilitating trust among parties involved.

Endorsements within this context are highly relevant for maintaining a secure, trustworthy, and efficient environment, where trust is often derived from the digital reputation and the authenticated support of community members or systems. By leveraging blockchain technology and encryption, endorsements are made immutable and tamper-evident, ensuring that they reliably reflect the support or approval of the endorsing party at the time of endorsement. This mechanism supports the overarching goals of the Community to foster a trusted ecosystem for exchanges, collaborations, and transactions.

An example method for endorsement may comprise following steps:

A request is made to endorse an Entity with an assertion.

A request to endorse may be a commencement of an approval Workflow (discussed in more detail below).

A determination is made by an Entity associated with the Community whether to accept the request.

Each user (Entity) approving the Endorsement needs to authorize via one of the associated authentication methods described herein.

This approval process may be performed via retrieving a message from the server (message may be a commitment comprising a nonce and approval information).

A signature is generated for the commitment/message.

The message is submitted back to the Application Programming Interface (API).

In the UI, this process can be performed via one button.

Once all relevant parties (Entities) have signed their commitment/message then the platform may request the Community key servers to produce the actual signatures and proofs that are applied to the endorsed Entities.

A request for Endorsement (or a request to endorse another Entity) is part of an approval flow that requires both Entities to sign a message. This signature is distinct from the signatures and proofs generated from the Origin itself and are signatures derived from an access method configured on the account. These methods may be used to control and authorize actions on the platform.

These methods may include or facilitate:

A Web3 based wallet that has been associated with the Origin Handle (such as a metamask wallet). This wallet could be associated with a key generated from the Origin itself and imported into a 3rd party wallet or eventually the Origin wallet.

An MFA process, such as a password login+Short Message/Messaging Service SMS code, which is used to reconstruct a signature via key derivation function (e.g., based on or similar to PBKDF2).

An issued API key and a key derivation function.

One or more of these methods may be used as authorizations which then allow the Origin Handle to be unlocked and used for key issuances/proofs/Endorsements etc.

### Revocation

There may be several methods for checking revocation, examples of which are discussed below.

When an Origin Endorsement is revoked, a new revision of the Endorsement is issued, and the metadata for the Origin for this reflects that when requested from the API.

When a project Endorsement is revoked, then similarly the API can reflect this. If the Entity produced has updatable metadata (such as an NFT contract which allows this), then that item will be updated too.

If the item has a physical representation of the Endorsements (such as a Quick Response (QR) code) then this may be submitted to a verifications API to see if these Endorsements are still valid.

### Workflow

As used herein, a ‘Workflow’ in this context refers to the sequence of processes through which an interaction from an Entity is managed, using an Origin Handle for identification and authentication. A definition is provided below:

Entity Recognition: The Workflow begins when an Entity initiates an Interaction. This Entity is recognized based on its unique Origin Handle.

Handle Validation: The Origin Handle associated with the Entity is validated to confirm the identity of the Entity and ascertain the legitimacy of the Interaction. This involves cross-checking the Handle using cryptographic techniques.

Interaction Creation: The Entity Endorses one or more participants to Interact on a set of Assertions attached to an Endorsement. The specific details of the Interaction initiated by the Entities are assigned to the Endorsement, pending signature. Permissions on how the Entities participate together on a Workflow are not confirmed until the signature process is complete. This process involves capturing data inputs, recording transaction details, logging communication messages and cryptographic signing.

Interaction Processing: The recorded Interaction is then processed according to predefined procedures or algorithms. This involves routing the Interaction to the appropriate parties, triggering certain actions and performing computations.

Signature Application: To ensure the integrity and authenticity of the Interaction, a digital signature is applied. This signature, which is linked to the Entity's Origin Handle, verifies that the Interaction has not been altered and that it originates from the authenticated entity.

Response Generation: After the Interaction has been processed and signed, the Workflow generates a response. This response could be a confirmation message, the result of a computation, or any other appropriate output.

Workflow Documentation: Finally, every step of the workflow, from initial recognition of the entity to the generation of the response, is documented. This record serves as an audit trail and aids in creating further Workflows, allowing accountability, troubleshooting, auditing and analysis.

This Workflow may ensure that Interactions from Entities, identified by their Origin Handles, are handled securely, efficiently, and transparently. The Workflow may provide a structured approach to managing Interactions via the associated assertions and Endorsements, ensuring that each one is authenticated, processed correctly, and properly documented. The Workflow can then be branched into sub-branches or paths for Alias Workflows.

When interacting with a workflow or community on one or a set of interactions the Entity origin can choose to issue a contextually scoped key for that interaction. In this scenario, this key will only be accepted on signatures that relate to the context and scope whether it be a workflow or community, and if that key is used to sign any other endorsement on the platform outside of this scope it will be rejected. When issuing the key the originating origin produces a “key proof” which signs a commitment hash on this key with a top level revision key. This proof is provided with the signatures on any endorsements made with the contextually scoped key so consumers can see this key was originally genuinely produced by the source entity. This can be useful for scenarios where deferred or delegated signing maybe required in a potentially semi-trusted environment. If a bad actor where to intercept this signing process and steal this contextual key then he has only compromised this process and not the origins themselves. This key can then be revoked and the process invalidated. Thus, as used herein, where a key is stated as being derived from or based on the Seed, this could also include a key as described above, which can be considered to be a ‘contextual key’. Thus, depending on the context, a key can be generated by an Entity and then signed with the commitment hash on this key. In case this key is compromised, this contextual key may be considered to provide a form of firewall that reduces the risk of the Origin being compromised.

Due to the flexible nature of the hierarchical derivation paths along many different types of signature such as secp256k1 or bls12-381 signatures do not always have to be applied by trusted nodes as with the correct choice of type of signature. Then the process of signing an endorsement could be distributed between many nodes using MPC signing techniques (or another type of distributed signing) preventing any one terminal/operator having access to a root key. Combined with contextually scoped keys this may create a environment where signatures can be applied on the behalf of entities with little risk to their secret keys being exposed

### Collaboration

Each collaborator (Entity) may be assigned its own private key (e.g., derived from the Seed). The mechanism allows each user (Entity) to have their own key and a customer may set their own rules about Interaction with a central repository.

An Entity may be predefined either as a project (e.g., which may refer to a Smart Contract Physical Product; Virtual Product, etc.), or a collaborator (e.g., user).

OS may revolve around signing metadata and commitments rather than explicitly files, NFTs, or other controlled data. This could be files or metadata for NFTs, fingerprinting for video or images or whatever commitment third parties or users are generating. These do not need to be stored by a service provider. It is possible to accept these metadata blobs to verification API's. These could be stored in whatever manner these users or third party should so wish. It is possible to provide a facility to host these files, fingerprints, metadata, or other items the third party has chosen to endorse and sign, but this is not a requirement.

Access to the project itself (rather than the end produced asset) to collaborate or endorse is an approval Workflow that can be considered to be similar to the Origin Endorsement process laid out above where a ‘join project proposal’ is put forth to a collaborator and when both parties sign then the user joins the project. Once joined, the collaborators can put forth ‘request for allocation’ proposals. For example, an Entity may want to sign five items, and once all collaborators have approved the allocation, then the project can use one signature each from each Origin Handle to prove and endorse those five items.

The following process may be followed.

Setup phase:
Step 1: Owner Name; Title/Description/Avatar Image; Public/Privacy=Tick/Untick Toggle.

Select Asset Type: Contract; NFT; Semi-Fungible Token (SFT); Metadata; Asset (if selected has the option for multiple).

As used herein, the term ‘CTA’refers to ‘Create Project’.

Step 2: NFT; Carry over info from above.

Add Collaborators & Endorsement for each role in the project (for each collaborator).

Add Assets either as 1 item (SFT/Metadata/Asset) or a list of items (NFT/Assets) dependent on the initial project setup.

Each Asset has metadata associated (Traits and Properties).

CTA=Sign and Mint (greyed out Call to Action—CTA until everyone has joined the project).

### Authentication

There may be multiple methods for key or secret splitting in use (such as Shamir's shared secrets for private key storage) but in the ‘wine’ example, the keys are a set of threshold keys. It is possible to have two methods for threshold keys within the platform used for threshold proofs e.g., Schnorr and Boneh-Lynn-Shacham (BLS). In the case of using both methods, it is possible to have a signature that is only verifiable if an Entity has access to both public keys (e.g., a 2-of-2 threshold). If one key is destroyed in the seal and unreadable then the signature can longer be verified.

### How Data May Be Stored

In some cases, the data is decentralized. If an Origin Handle agrees to join the Community as a member (Entity), the Entity needs to share certain proof with the Community owner. Certain aspects of the data may stay with the owners of that Community, however, this is expected to be clear to the Origin User joining. For example, such information may be displayed on the Community page by the owner prior to any Origin users (Entities) joining.

In some cases, public data may be stored but unencrypted.

In some cases, private data is not stored by a service provider. Such data may be encrypted in transit and at rest, and may only be available on request by the owner and verified partners (i.e., Entities associated with the Community associated with the owner) who the owner can nominate accordingly. Such a concept may be referred to as a ‘Grant’ with a key to decrypt the data.

This data may be stored on various nodes and may only be accessible to be decrypted once a designated user has been given a Grant. It is unlikely to be possible for a normal user without the Grant to access or request the information. That is, if there is no key for another Entity, there can be no request by that other Entity to access the information.

Users can combine one or more of the following concepts to secure the data: Access tokens; Decryption key; Zero-knowledge proof.

With one or more of the above concepts, users (Entities) can then unlock and gain access to the private data.

With regards to data such as Personally Identifiable Information (PII), Know Your Customer (KYC), Anti Money Laundering (AML), etc., a service provider may not be expected to store this type of data. It is possible to prove the data and public data that is distributed around nodes to be retrieved by authorized parties (Entities) via Grants.

A requester may receive such information once the data is provided by the point of authority of that data (e.g., the Community). This approach is changeable dependent on the use case. An example scenario is given below.

Step 1: A requester requests data.

Step 2: An Origin Handle approves request based on the requester criteria.

Step 3: The requester accesses data and pulls the information required at that point in time.

Step 4: Complete Transaction. The data is then no longer shared, so that if access to the data is required again, the same process as indicated above needs to be repeated.

As above, personal information may be a hashed proof, only accessible and decrypted by a Grant from a Community or designated Origin Handle.

A Commitment may be made from hashes of unique identifiers. This Commitment may be associated to the Origin being endorsed, the endorser Origin, signature and key proof. This creates a commitment chain. A purpose of a commitment chain is to enable secure and trust-less transactions (i.e., a type of Interaction) between participants in a decentralized network, without the need for every transaction to be recorded on the underlying blockchain. This then links out to the Origin role and assertion(s) information for the Endorsement to be kept on distributed nodes securely.

### Applicability to Physical Realm

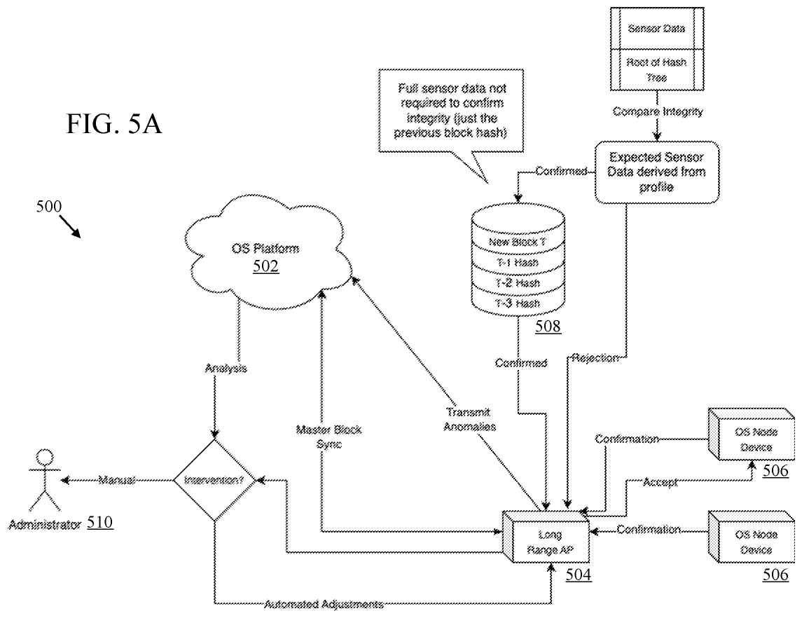

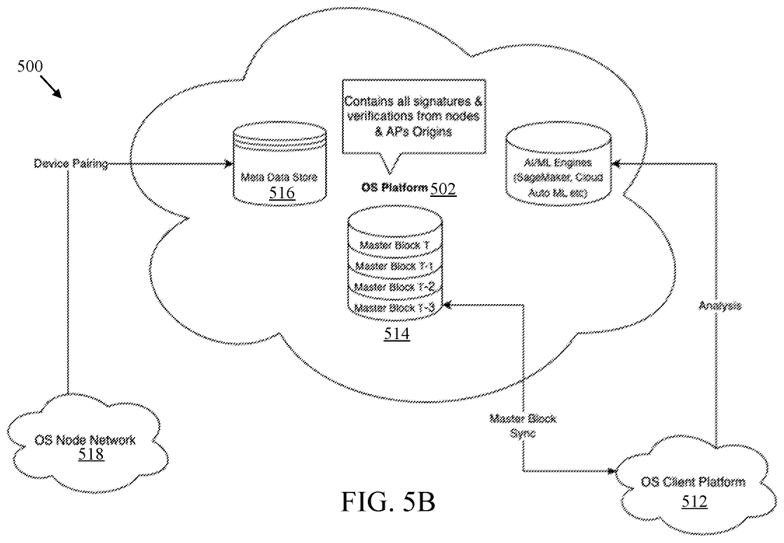

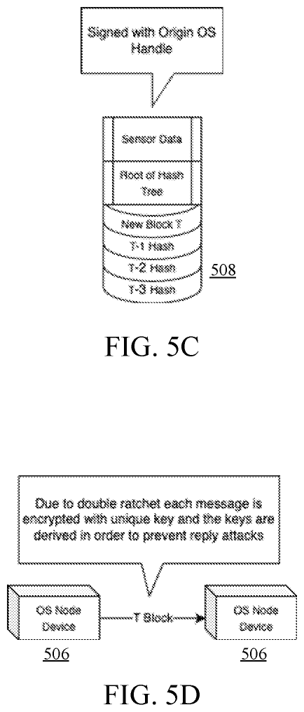

FIGS. 5A-5E refer to parts of a schematic diagram depicting a system 500 for implementing various techniques of this disclosure. The system 500 facilitates monitoring of physical Assets, for example, in a supply chain, or more generally in any scenario where it is helpful to monitor the status of one or more physical Assets. An example use case for the system 500 could be for tracking Assets such as shipping containers, or Assets in shipping containers. Another example use case for the system 500 could be for tracking wine (as already discussed). These are merely examples of cases where there may be a desire to monitor Assets associated with a Community.

In general, the system 500 may implement communications between one or more computing nodes (implemented by computing devices) in the physical realm that are associated with physical Assets and one or more computing devices (e.g., in the cloud) that underpin the backbone infrastructure of the system 500. If the communications indicate that one or more of the computing nodes have been interfered with, the OS platform may be informed of such and take appropriate action. Depending on the context, this could involve revoking or changing a status of one or more Entities (e.g., the physical Asset itself, or other Entities that interact with the physical Assets in the real world). Any of the computing nodes/computing devices referred to in relation to the system 500 may implement one or more of the various techniques described herein to facilitate the described functionality of the system 500. For brevity, not all of these computing nodes/computing devices are shown because there are multiple ways to set up the system 500. Any functionality described below may be implemented by one or more computing nodes/computing devices in any appropriate arrangement. Any arrows in FIG. 5 indicate communications between or via one or more computing nodes/computing devices. Not all elements depicted in FIG. 5 need to be present and/or the elements can be set up in a different way to that depicted. Thus, the principles of the system 500 can be modified to be used in various different contexts.

FIG. 5A depicts a part of the system 500 including the OS platform 502, which in some cases can be implemented in the cloud. The OS platform 502 facilitates the various Interactions which takes place in the system 500.

The OS platform 502 is communicatively coupled to an access point (AP) 504 (also referred to as a long range AP, but could be any type of access point). An AP 504 can facilitate communications between nodes coupled to or provided in one or more of: a cellular network (e.g., based on 3G, 4G, 5G, 6G, etc. concepts), satellite network, optical network, local area network, wide area network, personal network, organization network, etc.

The AP 504 is communicatively coupled to one or more computing nodes 506 that are associated with physical Assets. In the depicted case, there are two computing nodes 506 each referred to as an ‘OS Node Device’.

The computing nodes 506 interact with the OS platform 502 via the AP 504 and other compute infrastructure described below. Such Interactions may include confirmations and acceptances (as depicted) as and when needed.

In an example, the computing nodes 506 include one or more sensors capable of performing one or more measurements indicative of the environment surround the physical asset. Data from such one or more sensors may be used to form a unique profile associated with a computing node 506. A hash based on a root of a hash tree may be derived from the profile. Such a hash may be used to form a cryptographic record (e.g., a first Hash block in a set of records 508, which could be stored on-chain or off-chain) of the computing node 506. As fresh data is collected, this data may be used to generate a new hash, which is cryptographically analyzed with respect to the previous record. If the expected sensor data is derived from the profile, then a new block T is added to the set of records 508. If not, a rejection is transmitted.

The concepts of on-chain and off-chain storage are now briefly discussed.

A ‘Private on-chain’ approach refers to a blockchain network that is restricted in terms of access and participation. In this setup, the ledger is only accessible to a specific group of users, such as an organization or a consortium of entities, who have been granted permission to participate in the network. Transactions and data on a private blockchain are encrypted and can only be viewed or validated by authorized participants. This model offers enhanced privacy and security, as well as faster transaction speeds and more efficient processing due to the limited number of nodes. It is commonly used for business-to-business transactions and within corporate consortia where trust is established through the network's controlled access.

A ‘Public on-chain’ approach involves a blockchain network that is open for anyone to join and participate in, without requiring permission. This means that anyone can view, send, and receive transactions, as well as participate in the consensus process. Public blockchains are decentralized and rely on cryptographic algorithms to ensure the integrity and security of the data recorded on the ledger. They are known for promoting transparency and inclusivity but can face challenges such as slower transaction speeds and higher costs due to the energy-intensive nature of consensus mechanisms like Proof of Work (PoW). Bitcoin and Ethereum are prime examples of public on-chain environments.

‘Off-chain’ refers to transactions or data processes that occur outside the blockchain network but are related to on-chain assets or activities. Off-chain methods are used to improve scalability and reduce costs by handling transactions or data storage in a way that does not require the consensus of the blockchain network. These transactions can be later aggregated, summarized, or referenced on-chain. Off-chain approaches often involve trusted intermediaries or second-layer solutions, such as the Lightning Network for Bitcoin, which facilitate rapid and cost-effective transactions. While offering efficiency and scalability, the off-chain approach relies on the security and trustworthiness of the involved parties, or the technology used for linking off-chain activities to the on-chain ledger if required at a later stage.

Any one or more of these on-chain and off-chain storage mechanisms may be employed by one or more aspects or embodiments described herein.

Returning now to the discussion regarding the system 500, the OS platform 502 may be synchronized with the set of records 508 via a master block, from which the subsequent blocks may be derived.

The OS platform 502 may perform analysis based on any received anomalies, as indicated by any rejections. Such analysis may lead to an intervention by an administrator 510 or automated adjustments that may cause one or more Interactions to occur. For example, if a computing node 506 is compromised, the status of the physical Asset associated with the computing node 506 may be revoked accordingly.

FIG. 5B depicts further details of the OS platform 502 and its interaction with an OS client platform 512, which could refer to the other components of the system 500 depicted by FIG. 5A or other components of the system 500 as described below.

The OS platform 502 maintains its own set of records 514 (i.e., master blocks T, T-1,T-2, 4-3, etc.) which are associated with the OS client platform 512.

The OS platform 502 stores the signatures and verifications from computing nodes 506 and APs 504.

The OS platform 502 further comprises one or more engines to implement its analysis with respect to the OS client platform 512. In some cases, such one or more engines may implement one AI/ML engines (such as SageMaker, Cloud Auto ML, etc.).

The OS platform 502 further comprises a metadata store 516 to store metadata associated with any Interactions in the network 518 of computing nodes 506 in the system 500. This metadata can also include any metadata indicative any pairing between computing nodes 506.

FIG. 5C depicts how sensor data can be signed with a key associated with an Origin Handle to form the set of records 508.

FIG. 5D depicts a communication between two computing nodes 506 as part of an Interaction. A block that is to be stored is transmitted from one of the computing nodes 506 to the other of the computing nodes 506. Due to a double rachet, each communication is encrypted with a unique key, derived from the Seed, in order to prevent reply attacks.

FIG. 5E depicts another network 520 of computing nodes 506 in the system 500 that are associated with another set of APs 504 that are paired with the OS platform 502. Each AP 504 is communicatively coupled to each computing node 506. Each computing node 506 is communicatively coupled to each other. A pairing procedure may be performed to pair the computing nodes 506 so that if analysis indicates a potential problem with one of the computing nodes 506, this may lead to revocation of the status of the other computing node 506. Each computing device 506 may have an associated profile derived from one or more sensor measurements. The profile is cryptographically recorded via the OS platform 502 so that any unauthorized changes can be detected in a similar manner to that described in relation to FIG. 5A.

Each computing node 506 is capable of generating a periodic or aperiodic communication (which can be referred to as a ‘heartbeat’ or ‘squawk’) indicative of the measurements provided to the computing node 506, and hence also indicative of the status of the physical Asset associated with the computing node 506.

If such communications indicate that one of the computing nodes 506 has been compromised, the other computing node 506 and/or the OS platform 502 may be informed accordingly.

A computing node 506 may be communicatively coupled to one or more sensors 522 that are capable of detecting a change of status of the computing device 506 such as in relation to its environmental conditions. For example, a change in temperature, humidity, location, movement, etc., may be detected by the sensor(s) 522, and an indication of this change may be communicated to the OS platform 502.

As such, the network of computing nodes 506 could be considered to represent a distributed sensor network that functions in a manner similar to a biological swarm, in terms of communication and response to a stimulus (in this case, tampering).

Potential functionality of this network 520 is now described.

Distributed Sensors: Each computing node 506 may comprise or be coupled to one or more sensors 522 equipped with some means of local communication, possibly through radio frequency (RF) signals, Bluetooth, or another low-power method.

Local Detection: If a node 506 detects tampering or another predefined condition, it sends a “distress” or “alarm” signal to one or more of its neighboring nodes 506.

Swarm Communication: Upon receiving the distress signal, neighboring nodes may amplify and retransmit the signal. This chain reaction may ensures that the signal gets propagated throughout the network 520, even if only one node 506 initially detected the threat.

Internet-Connected Node: Among the swarm of devices, there may be one or more nodes that have the capability to connect to the internet (either they are always connected or can establish a connection upon receiving the distress signal). Once these nodes receive the propagated alarm signal, they send a notification to a centralized system or API.

Centralized Monitoring: The centralized system, upon receiving a tampering alert, can take appropriate action. This could include notifying security personnel, logging the event for analysis, triggering an audible alarm, etc.

Redundancy: The distributed nature of this system ensures that even if several nodes are disabled or tampered with, the network can still function. The more densely packed and numerous the nodes, the more resilient the system.

Distributed Ledger Technology (like Blockchain): Each action or event can be confirmed by a series of nodes before being logged, ensuring data integrity.

Record/Analysis and Report: These Alarms may be OS signed events that can then be propagated to the system 500 on connection.

One or more of these concept shares similarities with certain principles:

Mesh Networks: Each device or node in a mesh network communicates with its neighbors to transmit data across the network. The distributed nature of mesh networks provides redundancy and resilience.

Biological Swarms: Much like how a school of fish or a flock of birds can quickly change direction when one member senses a predator, the network rapidly propagates the alarm signal when tampering is detected.

Such a “swarm” system of static devices would be particularly robust against tampering, especially in environments where security is paramount. A challenge lies in ensuring seamless communication between devices, efficient power usage, and rapid response times. The system 500 may provide a solution to one or more of the challenges described herein.

Accordingly, any change detected by a computing node 506 may be analyzed and a determination may be made as to whether any action needs to be taken in response to the change. In some cases, the changes may be indicative of security or integrity being compromised, and hence an Entity such as an owner of an Asset being monitored by the computing node 506 may take appropriate action to ensure that a recipient of the Asset does not trust the status of the Asset.

### Further Explanation of Assertions, Endorsements, and Revisions

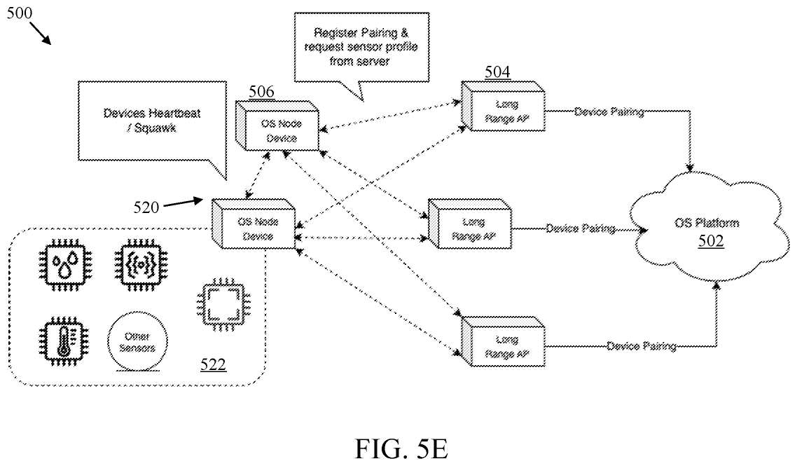

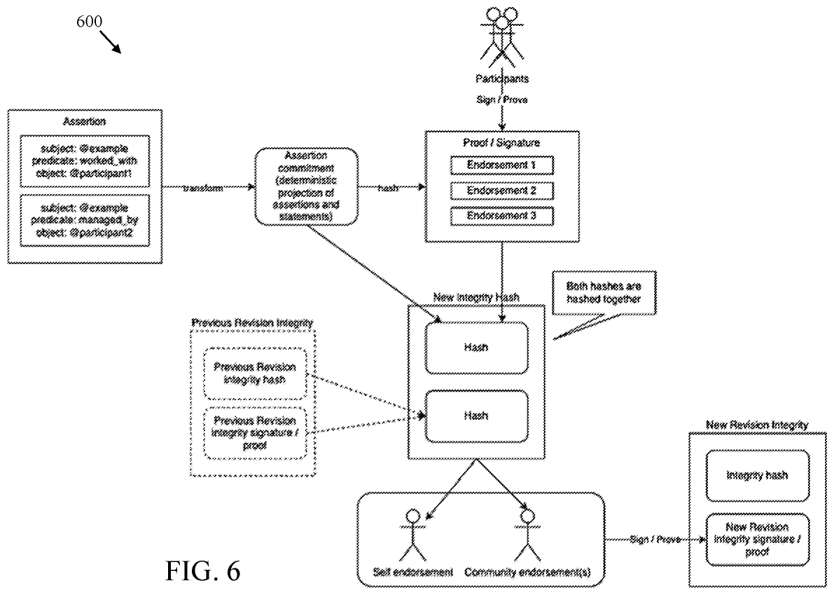

FIG. 6 is a schematic depicting a system 600 for implementing assertions and endorsements according to one or more embodiments described herein.

An Assertion may comprise one or more statements, potentially including one or more data entities, indicative of certain information of interest. In the depicted system 500, the Assertion comprises two data entities, each data entity being in the form of a triplet (e.g., an RDF triple). In this case, the data entity comprises a subject, predicate, and object. Other types of data entities could be used depending on the implementation. The data entity format may allow for semantic querying of the content of the data entity. As depicted, the content could be represented by a character string which be suitable for querying and may or may not be human readable, though will be machine readable. In an example, the subject can be represented by ‘@example’, the predicate can be represented by ‘worked with’ or ‘managed_by’, and the object can be represented ‘@participantl’ or ‘@participant2’. These examples are not to be construed literally; instead they represent functional content of the data entity that can be used for the purpose of an Assertion as described herein.

In accordance with the system 600, an Assertion can be transformed into an Assertion Commitment, which is a deterministic projection of the Assertion(s) and statements (e.g., in the form of a hash).

Such a hash can be endorsed by one or more participants (i.e., Entities) associated with a Community. A participant does not see or access the content of the data entity in the Assertion, unless that is needed in some implementations. An Endorsement can be considered to represent a proof that a participant signed/proved the Assertion Commitment (i.e., hash). It is noted that this system 600 does not necessarily require significant human input; rather the system 600 may ensure that any Assertion has the opportunity to be proven by participants associated with the Community (e.g., providing a participant is online, the system 600 can automatically collect their Endorsement, although in some cases the system 600 could require a participant to provide their input). In the depicted case, Endorsements 1 to 3 can be generated based on the hash of the Assertion Commitment, though any appropriate number of Endorsements may be generated. One or more Endorsements and the Assertion Commitment are combined to form a new ‘Integrity’ Hash which forms part of the integrity when combined with the previous integrity hash, indicative of the Assertion being endorsed by one or more participants. The Integrity Hash represents a proof of integrity of the Assertion because it has been signed by (i.e., Endorsed by) one or more participants associated with the Community. Thus, the Hash represents a form of signature that can be used to prove which participants endorsed the Assertion Commitment.

A previous Integrity Hash may have been generated based on a previous Assertion (represented by the ‘Previous Revision Integrity’). This is referred to as a ‘previous Revision’ because it represents a state at a previous time. Again, the previous Revision represents a form of signature proving which participants Endorsed the previous Assertion Commitment.

In this implementation, the new Integrity Hash is hashed together with the previous Integrity Hash.

The new Integrity Hash can then by used for the purpose of self endorsement or in connection with one or more Community Endorsements for the purpose of signing/proving any new Revision Integrities.

It will be apparent that above implementation generates a chain of hashes, and the link between the hashes will be cryptographically provable in manner analogous to blockchain (though it should be understood that the implementation of the system 600 may be on-chain or off-chain).

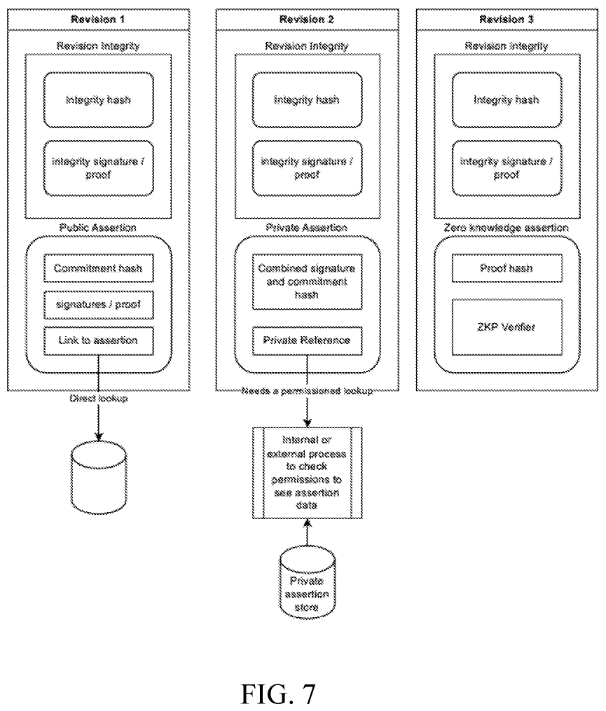

FIG. 7 is a schematic diagram depicting different types of revisions that can be used according to one or more embodiments described herein.

Revision 1 is a possible type of Revision Integrity such as may be implemented in the system 600 of FIG. 6. In this case, there is a Public Assertion comprising a Commitment Hash, signatures/proof and a link to an Assertion. The link could provide means for an Entity within a public domain to perform a direct lookup of the Assertion e.g., in a database.

Revision 2 is another possible type of Revision Integrity such as may be implemented in the system 600 of FIG. 6. In this case and in contrast to Revision 1, there is a Private Assertion. The Private Assertion comprises a combined signature and Commitment hash, as well as a private reference. A permissioned lookup system may be implemented whereby the private reference is only accessible based on satisfying an internal or external process to check permissions to see assertion data. Upon satisfying the check, access is provided to a private assertion store e.g., in a secure database.

Revision 3 is another possible type of Revision Integrity such as may be implemented in the system 600 of FIG. 6. In this case and in contrast to Revisions 1 and 2, there is a zero knowledge Assertion. The zero knowledge Assertion comprises a proof hash and a zero-knowledge proof (ZKF) verifier. This implementation may provide a form of proof about an Assertion having been endorsed without providing access to the data in the Assertion.

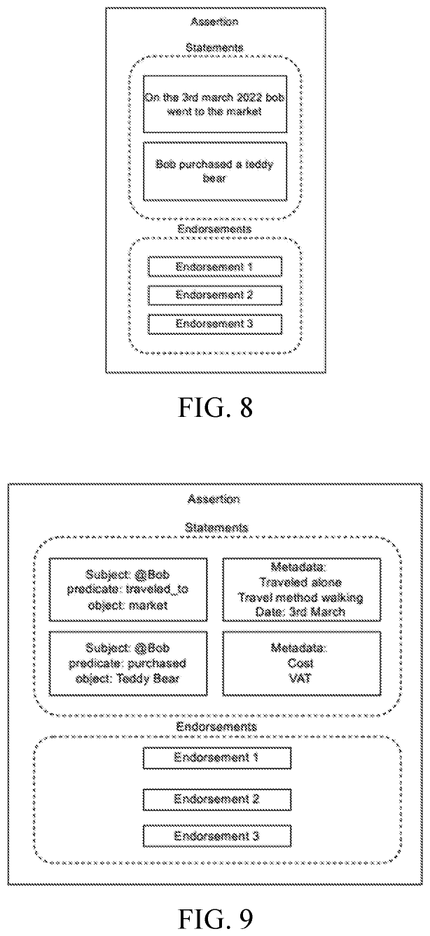

FIG. 8 is a schematic diagram of a type of assertion that can be used according to one or more embodiments described herein. In this case, the Assertion comprises one or more statements (two in this example) and is associated with one or more Endorsements (three in this example). Examples of statements may comprise or otherwise indicate ‘on the 3rd March 2022 Bob went to the market’ and ‘Bob purchased a teddy bear’. In accordance with the principles of the system 600, Endorsements may be generated based on the statements, thereby facilitating cryptographic proof that the statements have been endorsed by one or more Entities associated with the Community. Although this is a simplistic use case, it can be recognized that this procedure has utility in a wide range of scenarios where it is useful to validate what an Entity did and/or when the Entity did something.

FIG. 9 is a schematic diagram of a type of assertion that can be used according to one or more embodiments described herein. In this case, which refers to a more complex scenario than depicted by FIG. 8, the Assertion comprises four statements. The statements comprise two data entities as described previously and two metadata portions. Any number of statements can be presented (e.g., one or more statements), and these statements may comprise one or more data entities and/or one or more metadata portions. In this case, the two data entities specify in triplet form the subject-predicate-object for the information represented by the statements of FIG. 8. In particular, the subject being ‘@Bob’, the predicates being ‘traveled_to’ and ‘purchased’, and the object being ‘market’ and ‘Teddy bear’. Again, these statements can be endorsed by one or more Entities associated with a Community.

The ability to include additional information in the form of metadata provides additional utility and flexibility to the procedure. In this case, a first metadata specifies ‘traveled alone’, ‘travel method walking’, and date ‘3rd March’. A second metadata specifies cost and value added tax (VAT). It shall be appreciated that the flexibility provided by this procedure allows any information of interest to be included in a statement and the statements can be in any form or structure (e.g., a structure such as the data entity described previously).

As such, it is possible to implement and facilitate interrogation of predictable hashes from relatively unstructured data in the assertions without having to define strict schemas (part of what makes it so flexible compared to other signing mechanisms).

As an example, deterministic hashes/commitments for complex data may be provided as follows:

In some cases, such hashes/commitments may be implementation based on JSON objects but with techniques to ensure storage or transmission methods do not affect the final hash. Examples of such changes could be storing as BSON inside a db (database) store. When the JSON is read back the keys are arrays will have be rearranged to maximise storage efficiency so will no longer match the JSON prior to storage.

In some cases, deterministic JSON hashing may work in the following manner:

Perform a depth first traversal of the object (requires non-cyclic objects)

At the edge/leaf nodes (objects):

Sort all keys alphabetically

Sort all arrays alphabetically and hash each value:

All arrays should only be arrays of primitives or hashes of previously collapsed nodes (see later).

Hash leaf node and replace value in tree with its a hash of it's stringified JSON (collapse the object.

As you now go up a level to the next node, this should now ALSO be a leaf node itself because all sub nodes have been replaced with hashes and any nodes in arrays have been collapsed into hash values (primitives).

Repeat previous step to collapse node into hash and replace node on parent with its hash.

Once top level node is found perform these same steps like before but instead of replacing node the final step produces the final hash:

Sort all keys alphabetically.

Sort all arrays alphabetically and hash each value.

Stringify final JSON object and hash.

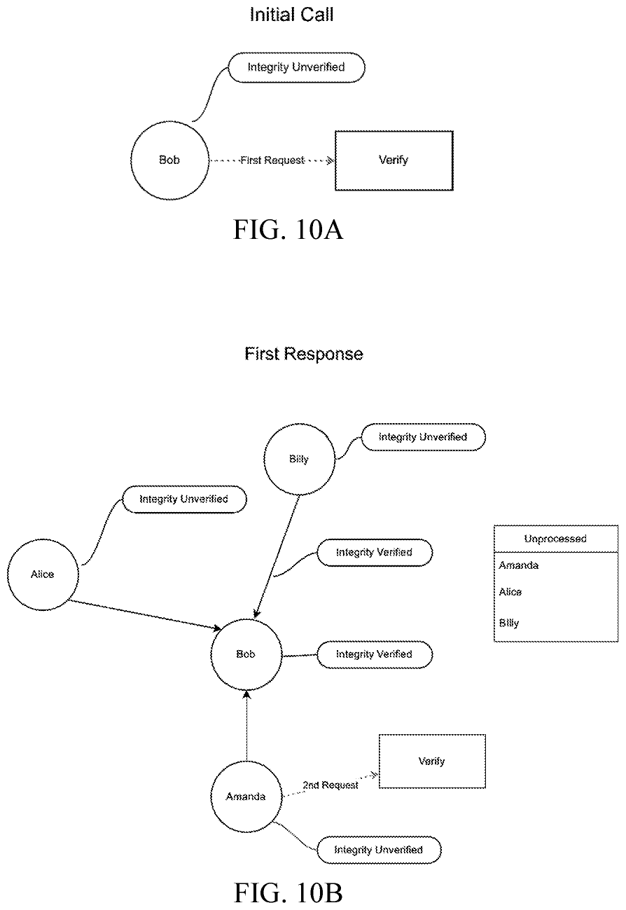

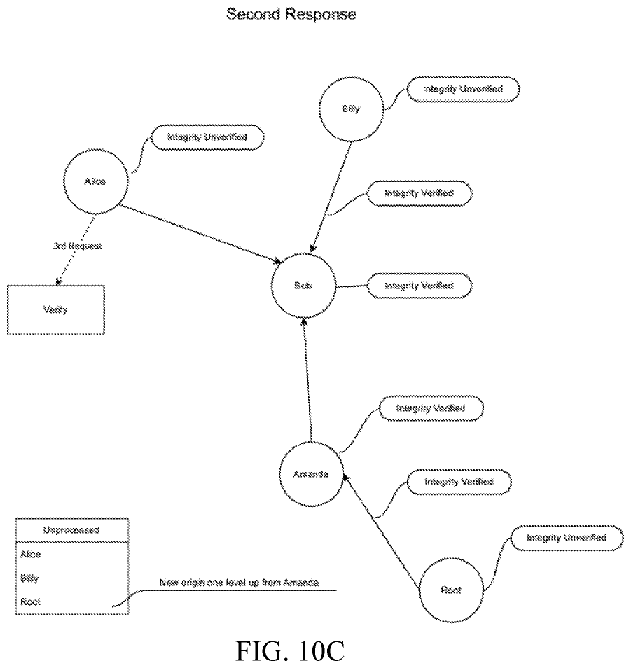

FIGS. 10A-10C depict a sequence of verifications that can be performed as new Entities interact with each other according to one or more embodiments described herein.

In FIG. 10A, Entity Bob makes a first request (e.g., comprising a new Assertion) as part of an initial call that needs to be verified by one or more other Entities (not shown). At this point, Bob's integrity is unverified.

In FIG. 10B, one or more other Entities (in this case Alice, Amanda, and Billy) can each verify (e.g., endorse) Bob's first request, thereby integrity verifying Bob. However, at this point Alice, Amanda, and Billy can be considered to be integrity unverified, or unprocessed. These unverified Entities can then make a second request for verification.

In FIG. 10C, a root (e.g., associated with an Origin Handle) can be used to verify the integrity of Amanda in response to Amanda's request. At this point, the root is technically integrity unverified and is unprocessed, along with Alice and Billy. Alice and Billy can then make requests for integrity verification. Thus, a chain of verifications can be built up, establishing trust within one or more Entities associated with a Community.

### Further Explanation of Various Concepts

Certain techniques described herein and/or certain aspects or embodiments may provide or facilitate one or more of the following technical advantage(s).

The OS may enable one or more Entities (e.g., members of Communities) to interact (e.g., create, collaborate, and/or trade assets) with one or more other Entities risk-free or at least at reduced risk. OS involves the use of one or more stages, including a unique verification, enforcement and approval process. This reduces or eliminates all known risks and potential future risks, associated with collaboration, authentication, sharing and insuring assets. Accordingly, the OS may enable individuals (Entities) and associated Communities to become a point of authority and create decentralized social proof. Enabling individuals and Communities to collaborate provides Social Proof, allowing them the ability to become a point of authority within their Community. The more points of Social Proof based authorities creates, the more decentralized the solution becomes, reducing or removing the risks within Digital Realms.

Further technical advantages will become apparent with reference to one or more aspects or embodiments described below. Such aspects and embodiments relating to or facilitating one or more of the concepts described herein are now described.

Aspects or embodiments described herein may be implemented by different logical Entities in the system. In some cases, the user defined by the embodiments is an already endorsed user e.g., authorized within an organization, as part of a project or otherwise trusted. In some cases, the user is a yet-to-be endorsed member for the Community or a project. Depending on the context, a computing device associated with a user (Entity) may implement the method according to one more aspects or embodiments described herein appropriately. The computing device that implements any of the concepts described herein may or may not be physically possessed by the Entity concerned (but in either case could be considered to be ‘associated with’ the Entity). For example, the computing device for use in implementing one or more concepts described herein may be remote to the Entity's own computing device used to access the functionality enabled by the platform.

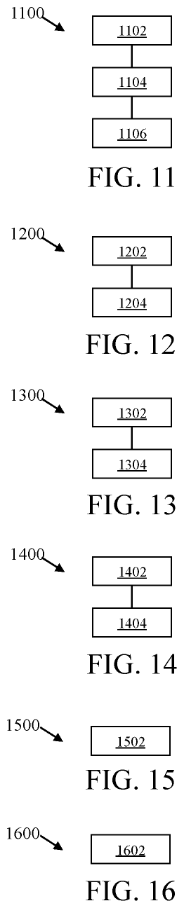

FIG. 11 is a flowchart of a method 1100 according to an aspect. The method 1100 is implemented by a computing device associated with an Entity (as already defined). Examples of a computing device are described below.

The method 1100 comprises, at block 1102, generating a Seed. In some implementations, the generation of the Seed may be performed in accordance with the principles discussed in relation to FIG. 3. In some implementations, one or more keys (e.g., a private key and/or public key, depending on the purpose at the time of derivation) can be derived from the Seed. Such one or more keys may facilitate one or more Interactions between the Entity and one or more other Entities associated with a Community. Thus, the Seed and the Community may be considered to be associated with each other.

The method 1100 further comprises, at block 1104, splitting the Seed into multiple shares. The splitting of the Seed may be performed in accordance with the principles described herein and discussed in relation to FIG. 3.

The method 1100 further comprises, at block 1106, transmitting a first share of the Seed to a first storage. The first share is encrypted with a first key associated with a Community. As highlighted previously, each share of a Seed may be stored separately. The first key is or may be derived from one or more keys derived from the Seed.

The method 1100 may facilitate a secure way to allow one or more Entities associated with the Community to make use of one or more keys deterministically derived from the Seed. Each key may be used for a specific purpose and no other purpose under the Community. Such purposes may be ultimately controlled by the Entity that owns/controls/has access to the Seed, though other Entities associated with the Community. No unauthorized Entity may have access to the Seed since it has been split up and encrypted, thereby improving the security of the system. Without access to the entire Seed, it is practically infeasible for an unauthorized Entity to perform unauthorized Interactions associated with the Community. However, authorized Entities may perform Interactions in accordance with their status. The architecture of the key derivation scheme, e.g., as depicted by FIG. 3, is such that a signature verification mechanism may be employed to allow Entities to verify any data signed with any of the keys associated with the Community since the keys that were used to sign the data are deterministically derived from the Seed. Accordingly, the method 1100 and associated embodiments may form part of a backbone ecosystem to facilitate Interactions associated with the Community.

By way of additional explanation of a Community, a Community may be considered to be a decentralized authority. In essence, the Community (decentralized authority) operates as a trust network where members (e.g., Entities associated with the Community) validate the actions of the Community, thereby ensuring the reliability and authenticity of the certificates and Endorsements provided to other Entities. The Community's decentralized nature may enable the Community to function autonomously, without relying on a centralized authority, thus providing a more secure and reliable method for facilitating Interactions between Entities such as issuing certificates/Endorsements. Where the term ‘Community’ is used, this does not necessarily imply that the shares are stored in the same member Community; rather the Community comprises a decentralized authority that facilitates the functionality of one or more embodiments described herein.

Some embodiments relating to the method 1100 and other concepts described herein are described below.

In some embodiments, the one or more keys are used to facilitate one or more Endorsements. As described previously, a key (which can include a contextual key) is generated and used to sign certain data. The signing of this data can be considered to represent an Endorsement of that data by the Entity. Thus, in some embodiments, the one or more Endorsements are used to endorse data comprising or derived from one or more Assertions (e.g., the data can be derived from an Assertion Commitment such as a hash of the Assertion Commitment). An Endorsement is an example of an Interaction.

In some embodiments, the Entity is to control an Interaction between a controlled Entity under control of the Entity and another Entity associated with the Community.

The Entity may be considered to be a ‘first’ Entity. The Entity to control the Interaction may be considered to be a ‘controlling Entity’, in that they control a ‘controlled Entity’. A ‘controlled Entity’ could be an asset under the control of the Entity (e.g., user). ‘A’ controlled Entity includes ‘one or more’ controlled Entities. ‘An’ Interaction includes ‘one or more’ Interactions. There may be multiple Entities.

As already indicated, there may be one or more Entities (which for ease of explanation we shall call ‘members’, but the explanation is not limiting to that example) that are associated with the Community (which may refer to a set of Interactions that all have a common purpose). It could be considered that the members belong to the Community. However, the term ‘Community’ is broader than that. For example, those members may perform one or more Interactions with each other and/or with any other Entities (such as assets) as part of the Community. Such Interactions may be controlled by one or more other Entities depending on their status. This could also include the ability to control any other Entity's Interaction with an asset such as a digital asset or other data that is associated with the Community.

In some embodiments, the Entity specifies a defined right of Interaction for the other Entity to interact with the controlled Entity.

In some embodiments, the defined right of Interaction comprises a right to one or more of: access; view; exploit; change; develop; and/or share the controlled Entity in part or in whole.

All of these Interactions may occur as part of an ‘Interaction lifecycle’.

In some embodiments, the method 1100 may further comprise performing an Interaction that comprises sharing the controlled Entity in part or in whole with one or more other Entities.

In some embodiments, the other Entity is permitted to perform an Interaction comprising sharing another controlled Entity in part or in whole with one or more other Entities.

Such permission may depend on each Entity's defined right of Interaction specified by the Entity that controls the Interaction with the controlled Entity.

In some embodiments, an Interaction key, derived from the Seed, is configured to facilitate an Interaction of the one or more Interactions. The term ‘Interaction’ when used in the context of the ‘Interaction key’ does not indicative a specific type of key. An ‘Interaction key’ is any key that can be used in any Interaction associated with the Community (where there may be multiple different types of Interactions that are performed between one or more Entities associated with the Community).

For example, a group of Entities (that are able to interact since they are associated with the Community) can mutually share one or more of their controlled Entities (e.g., their assets) in whole or in part providing they are associated with the Community.

In an example, an Entity (e.g., a controlling Entity such as a member associated with the Community) may specify the right for another Entity (e.g., another member or potential member to be associated with the Community) to interact with another Entity (e.g., a controlled Entity such as an asset or another member) depending on each Entity's right to interact, as specified by the (controlling) Entity. In an example, where the Entity is a user with an asset (e.g., controlled Entity), the user may specify one or more conditions in order for any other Entity (e.g., user) to interact with that asset. Those conditions may be specific to each other Entity, thereby setting another Entity's right to interact with the asset according to the Entity's preference. In another example, where the Entity is a user (e.g., controlling Entity) able to control another Entity's (e.g., another user) interactions within the Community, the controlling Entity may be able to define what kind of Interactions are permitted between the other user and further Entities associated with the Community. As already indicated, an Entity can have a broad range of definitions, thus the examples given here are not limiting.

In some embodiments, the Interaction key is configured to provide a second Entity associated with the Community with a specified right to interact in part or in whole with one or more other Entities associated with the Community.

A second Entity could be the ‘other’ Entity, but not necessarily. A group of entities that are able to interact in association with the Community may include further Entities such as a third Entity that could be the ‘controlled Entity’, but not necessarily. Such a third Entity may be an asset, such as a proprietary asset of the first Entity.

In some embodiments, the specified right to interact in part or in whole with another Entity comprises one or more of: an Interaction that requires no access to a third Entity associated with the Community; or an Interaction that allows the second Entity to: access, view, exploit, change, develop, and/or share the third Entity in part or in whole.

For example, a set of restrictions (e.g., by virtue of one or more keys) may be placed on one or more Entities such that one or more Interactions are facilitated between Entities, whilst maintaining the ability to specify what Interactions are permitted according to the preference of the (controlling) Entity. In some cases, a controlling Entity may specify that another Entity cannot interact with (e.g., access, etc.) a controlled Entity (such as an asset under the control of the controlling Entity) but still be able to interact in association with the Community. It follows that a controlling Entity may specify that another Entity can interact with (e.g., access, etc.) a controlled Entity (such as an asset under the control of the controlling Entity).

In some embodiments, the Entity is associated with one or more of: an application, an individual, an organization, and/or a community of Communities, wherein the second Entity is associated with one or more of: an application, an individual, an organization, and/or a community of Communities, and wherein the third Entity is associated with an Asset In some embodiments, the method 100 further comprises transmitting a second share of the Seed to a second storage. The second share may be encrypted with a second key, of the one or more keys, associated with the Community.

In some embodiments, the second storage is isolated from the first storage.

These ‘storages’ could be in dedicated regions of the same memory or completely different memory units at different distinct locations.

In some embodiments, the second key is different to the first key.

In some embodiments, the Seed is generated from a mnemonic.

In some embodiments, the mnemonic is specified by the Entity or supplied to the Entity.

In some embodiments, the Seed is split into multiple shares using a secret sharing protocol. For example, a secret sharing scheme may include Shamir's shared secrets.

In some embodiments, the Seed is useable to deterministically derive one or more cryptographic keys for use in one or more operations.

Where allowed by the context, a key such as a cryptographic key may be referred to herein as an ‘Interaction key’. An Interaction may include an operation.

In some embodiments, the one or more Interactions (which could also be referred to as ‘operations’ in some cases) include one or more of: (i) an Endorsement Interaction; (ii) an aggregate proof Interaction; (iii) a blockchain Interaction; (iv) a threshold proof Interaction.

In some embodiments, the one or more Interactions facilitate one or more of: (i) project creation and/or management; (ii) Handle management; (iii) community proof; (iv) issuance proof; (v) cryptocurrency account management; (vi) digital asset management.

In some embodiments, the derived one or more keys comprises one or both of a private key and a public key of a key pair. As used herein, a ‘key’ may be considered to be a cryptographic key.

In some embodiments, the derived one or more keys are single use for an Interaction such that a new key is to be derived based on the Seed for a subsequent or different type of Interaction. The key may be derived on demand, or previously derived and saved in an appropriate location accessible to the Entity for future use. In other similar words, each key may be reserved for a specific purpose as defined by an authorized Entity associated with the Community.

In some embodiments, the Interaction has a different context to the subsequent or different type of Interaction. The different context may refer to different tasks in one or more Workflows, such as: creating a project might involve use of a first private key to sign any data; endorsing a user might involve use of a second private key to sign data.

In some embodiments, the method 1100 comprises: deriving a first private key of the one or more keys for a first Interaction; and using the first private key to sign data associated with the first Interaction.

In some embodiments, the method 1100 comprises: deriving a second private key of the one or more keys for a second Interaction; and using the second private key to sign data associated with the second Interaction.

In some embodiments, the method 1100 comprises deriving an indication of proof of identity of the Entity.

In some embodiments, the indication of proof of identity comprises one or more of: a Handle associated with the Entity, contextual metadata and/or assertions; and a proof key derived from the Seed e.g., with a cryptographic proof of the provenance of that key.

In some embodiments, the method 1100 comprises transmitting the indication to one or more other Entities associated with the Community such as Community endorsers.

In some cases, the other Entity may perform one or more of the following Interactions, including: proving data (e.g., proving that one or more Endorsements are correct), endorsing data, and/or notarizing data, etc.

In some embodiments, the method 1100 comprises, in response to being endorsed by the one or more of the other Entities associated with the Community, receiving an indication that the Entity can interact with one or more other Entities associated with the Community.

For example, the Entity may be a user that has joined a group of Entities that are associated with the Community. The Entity (user) may be permitted (e.g., by one or more other Entities) to perform one or more Interactions associated with the Community according to a right to interact associated with the Community.

In some embodiments, the indication is indicative of a proof that the Entity can interact with one or more other Entities associated with the Community.

In some cases, the ‘proof’ may be a community proof and/or a social proof. The proof may indicate that the Entity can belong to the group of Entities that can interact where they are associated with the Community.

In some embodiments, the method 1100 comprises comprising performing one or more Interactions as part of or in conjunction with the one or more other Entities.

In some embodiments, the method 1100 comprises receiving a proof key indicative of a request by a new Entity to interact with one or more other Entities; and in response to the Entity authorizing the request, signing the proof key with an endorsement key derived from the Seed.

In some cases, the new Entity is a new member wishing to interact with one or more Entities that can perform one or more Interactions associated with the Community. In this context, the interaction may comprise a Group Interaction. A Group Interaction may be where one or more Entities (associated with the Community) interact with the new Entity, for example, as part of a process to allow the new Entity to participate in Interactions associated with the Community (e.g., join the Group of Entities associated with the Community and/or access, view, exploit, change, develop, and/or share a controlled Entity).

Any of the keys, including the proof key, described herein may be derived from the Seed. The terminology used to refer to each key is for the purpose of distinguishing between different keys, rather than indicating that the key has a specific property. For example, in the above method, a proof key could be considered to be a ‘first’ key, and the endorsement key could be considered to be a ‘second’ key. Similar logic applies to any of the other groupings of keys referred to in any of the methods or concepts described herein.

In some embodiments, the method 1100 comprises comprising: receiving one or more signed proof keys associated with a request by a new Entity to be associated with the Community. In some cases, the method 1100 may further comprise generating a new proof indicative of the new Entity being allowed to interact in part or in whole with one or more other Entities associated with the Community. In some cases, the method 1100 may further comprise generating a revised proof indicative of an existing Entity being associated with the Community and/or being allowed to interact in part or in whole with one or more other Entities associated with the Community.

In some cases, the new Entity may be a new member wishing to be associated with the Community. The new proof may comprise a community proof. In some cases, the new proof indicate that the new Entity is socially proved by (e.g., endorsed by) one or more other (existing) Entities associated with the Community. In some cases, the revised proof may comprise a community proof. In some cases, the revised proof may indicate that an existing Entity is socially proved by (e.g., endorsed by or otherwise socially proven by) one or more other existing Entities. Such a proof may indicate the extent to which an Entity can interact in associated within the Community (e.g., the proof may indicate an Entity's status in order to perform a particular type of Interaction of a set of possible Interactions).

In some embodiments, the indication of proof includes a public key associated with the indication, to facilitate verification of the indication. The proof key (an example of the “indication of proof”) may have a JavaScript Object Notation (JSON) structure or other appropriate structure. The indication of proof may include all the information needed to verify the proof key.

In some embodiments, the Entity is a single point of authority.

In some embodiments, the method comprises obtaining a Handle associated with the Entity. In some cases, the computing device may generate the Handle or otherwise derive or construct the Handle.

In some embodiments, the Handle identifies the multiple shares of the Seed.

In some embodiments, the Handle identifies information about an Interaction such as an Endorsement. An Endorsement may be made by the Entity or received by the Entity. For example, the Handle may identify information about an Endorsement and/or a social proof.

In some embodiments, the Handle comprises a front end visible to the Entity and a back end comprising information to facilitate reconstruction of the Seed.

In some embodiments, an Interaction associated with the Community is used to prove the Handle.

For example, the Interaction may comprise an endorsement interaction or other form of social proof that allows the Handle to be endorsed to be associated with the Community, and thereby indicate that the Handle can be involved in one or more Interactions that occur within the Community.

In some embodiments, each Entity associated with the Community has its own unique Handle and associated Seed, and wherein one or more of the Entities combine to create an aggregate signature to act as an initial proving signature for the Handle associated with the Entity.

In some cases, one or more Entities associated with the Community may represent endorsers associated with the Community (e.g., to endorse any type of Entity associated with the Community). The one or more other Entities may interact with Handle associated with the Entity in order to form a proof (e.g., a social proof) indicative that the other Entities recognize and/or approve the Handle associated with the Entity (in order for that Entity to interact in part or in whole with one or more other Entities associated with the Community, depending on the Entity's status for that Community).

In some embodiments, the method comprises: obtaining an indication of a commitment; signing the indication with a private key derived from the Seed; and transmitting the signed indication.

In some embodiments, the indication of the commitment comprises a nonce and approval information.

In some embodiments, the indication of the commitment is obtained from a serving module, and wherein the signed indication is transmitted to the serving module or another serving module. A serving module may include one or more servers, processing nodes, etc., implementing one or more APIs. The serving module may be implemented by any appropriate computing device or computing node in the platform.

In some embodiments, the serving module is configured to produce one or more signatures and/or proof to be applied to endorse the Entity and/or another Entity in response to determining that one or more specified other Entities have signed their indication and transmitted the signed indication to the serving module.

In some cases, an “Entity” may be a project such as a smart contract, physical product, virtual product, etc. In some cases, an Entity may be a “collaborator”, i.e., a user. In some cases, a user could be an AI.

In some embodiments, the method comprises: retrieving a message from a serving module; signing the message with a private key derived from the Seed; transmitting a package comprising the signed message to the serving module and/or another serving module.

In some embodiments, the package further comprises one or more of: a public key derived from the Seed; an indication of proof, and witness information.

The witness information may be any indication that the user (Entity) and/or one or more Community members (other Entities associated with the Community) have endorsed or agree to endorse a new member. The public key may be associated with the master key, or may be deterministically derived in the key hierarchy.

In some embodiments, the indication of proof does not include a private key, or any other information that would otherwise adversely affect the privacy of a user/Entity.

Since use of the indication of proof (derived from use of the proving key) indicates that the Entity is indeed who they say they are, and a third party can verify that via an available public key associated with one or more private keys derived from the master Seed.

In some embodiments, the indication of proof is for implementing a zero-knowledge proof.

In some embodiments, the method 1100 comprises verifying a signature associated with an Entity and/or another Entity using a public key associated with the Entity and/or other Entity.

In some embodiments, the Entity is a new or soon-to-be new Entity to be associated with the Community, the method 1100 further comprising receiving a package comprising a message signed by an existing Entity associated with the Community. The package may be indicative that the existing Entity endorses the new or soon-to-be new Entity to be associated with the Community.

In some embodiments, the package further comprises one or more of: a public key derived from a Seed of the existing Entity; an indication of proof, and witness information.

In some embodiments, the method 1100 comprises using the received package to attest that the Entity is associated with the Community. In some cases, the package may be considered to be indicative of a community proof.

In some embodiments, the method 1100 comprises signing data using a private key deterministically derived from the Seed. In some cases, the data may be associated with a project.

In some embodiments, a Handle associated with the private key is part of (e.g., contained with) signature metadata.

In some embodiments, the method 1100 comprises obtaining signature metadata; and verifying that the signature was produced by a specified Entity by checking the specified Entity's key issuance proof against an issuance key associated with the specified Entity.

In some embodiments, a Handle associated with the specified Entity's key is within the signature metadata.

In some embodiments, a public key related to the Handle is within the signature metadata.

In some embodiments, the method 1100 comprises: endorsing an Entity to produce an Endorsement. The Endorsement may be encrypted and/or require proof of access to unlock data associated with the Entity.

In some embodiments, the method comprises receiving a message signed by another Entity as part of a Workflow that requires the Entity and the other Entity to sign a message. The respective signatures applied by the Entity and the other Entity may be derived from an access method configured for the respective Entity and other Entity.

A Workflow may comprise one or more Interactions. Similarly, an Interaction may be part of one or more Workflows. In an example, an Entity may perform a Workflow that spawns one or more Interactions with another Entity. In an example, an overall Workflow may have multiple Interactions involved with the Workflow. In an example, a sub-interaction itself may be an approval Workflow. Thus, in some cases, a Workflow may comprise an approval Workflow and/or other types of Workflows.

The term ‘message’ as used herein may refer to a communication (e.g., a communication object) within a platform or across multiple platforms. For example, a communication may refer to any one of: a part of a sign-in/out procedure such as a sign-in attempt, verifying a sign-in, indicating sign-out, etc. ; transmitting a prompt from a device to another device via a network; and/or broadcasted information, etc. Thus, a message can refer to any data for any purpose transmitted from one node to another node within a platform or across multiple platforms. In the above example, the message facilitates functionality of one or more Interactions as part of the Workflow.

In some embodiments, the method comprises transmitting a message signed by the Entity as part of a Workflow that requires the Entity and another Entity to sign a message. The respective signatures applied by the Entity and the other Entity may be derived from an access method configured for the respective Entity and other Entity.

In some embodiments, the message signed by the Entity is different to the message signed by the other Entity. Each message may be retrieved from one or more serving modules.

In some embodiments, the access method is based on one or more of: a Web3 (or WebX) based wallet that has been associated with a Handle associated with the respective Entity; a Multi Factor Authentication (MFA) process used to reconstruct a signature via a key derivation function; an issued Application Programming Interface (API) key and a key derivation function; future authentication methods including one or more of: future web X wallets, physical devices, biometric scanning, or digital identity providers/wallets; an Alias associated with the Entity; and/or a temporary key issued by a trusted Entity. The wallet may be a metamask wallet. The key may be generated from the Handle and imported into a third party wallet or another type of wallet. An MFA process may include one or more of a password based login plus SMS code, authentication app, smart card, etc. The key derivation function may include PBKDF2.

Where referring to future authentication methods, this means that the system is designed to be future-proofed by virtue of being compatible with such methods.

In an example, it may be possible for an Entity to log in via an Alias, which gives the Entity access to a certain sub-section of possible Interactions. These possible Interactions may not necessarily be everything that the Entity can is permitted to do based on their Origin Handle. However, once associated with their Origin, the Entity may perform the full range of Interactions as permitted according to their status. For example, certain sub-sections of behavior can be limited to an Alias within a Community. In some cases, a login using the Alias may be based on a key associated with the Alias e.g., for a specific platform, rather than the overall Origin login key.

In an example, an Alias can act as a Notary (e.g., for notarizing data) and/or facilitate a notarization interaction with respect to a Community. An Alias may be used for an Interaction. For example, when interacting within a Community that is acting as a Notary, the Alias may be used to provide a form of firewall between the Entity (which could be outside the Community) and the other Entities (that are associated with the Community).

In an example, the temporary key may be associated with the Community or a Handle.

The temporary key may facilitate an off-line Interaction. For example, the temporary key may comprise a local key issued to a device associated with the Entity. Such a temporary key may have an expiry date that allows the Entity to interact (e.g., sign data when performing for offline work).

In some embodiments, the access method is used as an authorization to allow a Handle to be unlocked and used for one or more of: key issuance; proof; and Endorsement. The access method may extend to other types of Interactions not listed here but described elsewhere in this disclosure.

In some embodiments, the method 1100 comprises causing an Endorsement of an Entity to be revoked.

In some embodiments, revocation of the Endorsement causes a new revision of an Endorsement to be issued for the Entity. Metadata associated with the revised Endorsement may be updated to reflect that another Entity no longer endorses the Entity.

In some embodiments, the method comprises using a private key deterministically derived from the Seed to sign one or more of: metadata and a commitment associated with an Entity such as an Asset.

In some cases, the commitment comprises one or more hashes of unique identifiers associated with the Entity (e.g., an Entity such as an asset). In some cases, the commitment is associated to one or more of: a Handle being endorsed; a Handle of an Entity such as an endorser; a signature; and key proof.

Metadata may refer to any data associated with any other data of interest. For example, the metadata may provide information such as one or more parameters, descriptive information, etc., about the data of interest. In an example, data may be video data, and the metadata may refer to any parameters that define something about the video data (e.g., video coding format, date, time, identifying information, script for the video, etc.).

In some embodiments, the Asset comprises one or more of: user information; a digital file; a digital asset; a watermark or fingerprint representative of a physical item or digital data; a biometric marker; a physical item represented by digital data; an electronic computer including one or more of: a central processing unit (CPU); bootloader or other trusted platform; a token; an Non-Fungible Token (NFT); a Semi-Fungible Token (SFT); code (e.g., computer readable instructions); a smart contract; training data for an AI; an AI model; and/or any other concept that can be represented in digital form.

As such, user information can be private. Instead, it is the associated metadata that may be signed using the private key.

In some embodiments, the method 1100 comprises requesting to join an Interaction or Workflow associated with the Community. The Entity and another Entity in the Community may sign one or more messages to facilitate the Entity joining the Interaction or Workflow.

In an example, the Interaction or Workflow may be part of a project.

In some embodiments, the method comprises receiving a request by another Entity to join an Interaction or Workflow associated with the Community. The Entity and the other Entity may sign one or more messages to facilitate the other Entity joining the project.

Where the Entity has joined the Interaction or Workflow, in some embodiments, the method comprises: obtaining a request to allocate one or more Interactions, Workflows, and/or proposals to one or more Entities associated with the Community; in response to a specified number of the Entities associated with the Community approving the allocation, signing the request to prove and/or endorse the allocation of the one or more Interactions, Workflows, and/or proposals. Thus, in some cases, a single signature could cover and endorse multiple items if a specified number of the Entities agree. It may be all of them, a threshold number/ratio of the Entities that need to agree.

In some embodiments, where the Entity has joined the Interaction or Workflow, the method 1100 comprises: defining an Interaction or Workflow; selecting an Entity (e.g., Asset) type; creating the Interaction or Workflow based on the selected Entity type. In some embodiments, the method 1100 further comprises associating one or more Entities with the community and endorsing each Entity for each role as part of the Interaction or Workflow.

In some cases, selecting an Interaction type comprises selecting an asset type. Associating one or more Entities with the Community may comprise adding the one or more Entities (e.g., users) to the Community and endorsing each Entity for a role to be performed by the Entity for the Interaction or Workflow.

In some embodiments, a product of the Interaction or Workflow causes: one or more tokens to be minted on a blockchain; a representation of a Handle to be minted on the blockchain; and/or a representation of data resulting from the Interaction or Workflow to be stored on-chain or off-chain.

On-chain means on a blockchain. Off-chain means not on a blockchain e.g., on some other storage for future use. In either cases, the representation is cryptographically provable that it is derived from the Interaction or Workflow and is associated with the Community.

In some embodiments, creating the Interaction or Workflow comprises minting one or more tokens on a blockchain.

In some embodiments, the method 1100 comprises requesting data associated with another Entity. The Entity may be a point of authority for that data. In response to the request being approved by the Entity, the method 1100 may comprise receiving the data.

In some embodiments, a Handle associated with the Entity is configured to approve the request based on criteria specified by the Entity. The Entity may be configured to obtain the data and transmit the data to the (requesting) Entity.

In some embodiments, the data is no longer sharable by the Entity after completion of the Interaction (e.g., transaction).

In some embodiments, the method 1100 comprises receiving a commitment. The commitment may comprise one or more hashes of unique identifiers associated with the Entity.

In some embodiments, the commitment is associated to one or more of: a handle being endorsed; a Handle of an Entity (e.g., the Entity or another Entity associated with the Community); a signature; and key proof.

In some embodiments, the method 1100 comprises storing a share of a public key in a storage of the computing device. One or more other shares of the public key may be shared with one or more other computing devices.

In some embodiments, the storage is configured to be deleted, and/or a status of at least the share of the public key is revoked, in response to the computing device being tampered with.

For example, the share of the public key and/or other shares of the public key may be revoked in such a way that they are not trusted if any of those keys (or associated private keys) are used again for another Interaction.

In some embodiments, the storage is associated with an identification tag which, when tampered with, prevents access to the share of the public key and/or a payload.

For example, the identification tag may comprise a radio-frequency identification (RFID) tag. An identification tag may comprise electronic circuitry or some other means (e.g., including non-electrical, visual, audible, etc.) that comprises or points to a location where the share of the public key can be found and used by an Entity.

In some embodiments, the method 1100 further comprises attaching the computing device to a physical Entity (e.g., physical Asset) to be tracked in such a way that if the physical Entity is tampered with or otherwise damaged, the computing device is to prevent access to the share of the public key and/or the payload.

FIG. 12 is a flowchart of a method 1200 according to an aspect. The method 1200 is implemented by a computing node associated with an Entity (as already defined). Examples of a computing node are described below with reference to the computer device which provides the functionality of such a computing node.

The method 1200 comprises, at block 1202, receiving a share of a Seed. In some implementations, the Seed is used to derive one or more keys for facilitating one or more Interactions between a plurality of Entities associated with a Community.

The method 1200 further comprises, at block 1204, storing the share in a memory accessible to the computing node. The share is encrypted. In some implementations, the key is encrypted with a first key, of the one or more keys, associated with the Community.

The method 1200 may be considered to be interrelated to the method 1100 and therefore facilitates or enables similar or related functionality as described in relation to the method 1100. The embodiments described in relation to the method 1100 may, where appropriate, be combined with, form part of, or be used in conjunction with the method 1100 and/or its related embodiments.

In some cases, the key may be associated with a community authority. The key may be associated with the target node that receives the share e.g., based on Elliptic Curve Integrated Encryption Scheme (ECIES).

In some embodiments, the Seed is generated by a computing device associated with an Entity.

In some embodiments, the method 1200 comprises, in response to a request, transmitting the share to facilitate reconstruction of a Seed and/or a Handle associated with the Entity.

For example, this may help to facilitate reconstruction of the Seed and/or Handle by the Entity (e.g., user).

In some embodiments, the share is transmitted in encrypted form or decrypted prior to transmission.

In some embodiments, the computing node is configured to produce one or more signatures and/or proof to be applied to endorse an Entity in response to determining that one or more specified Entities associated with a community have signed an indication and transmitted the signed indication to the computing node.

FIG. 13 is a flowchart of a method 1300 according to an aspect. The method 1300 is implemented by a computing device associated with a Community. Examples of such a computing device are described below.

The method 1300 comprises, at block 1302, verifying a signature applied to metadata by a new or existing Entity associated with the Community. In some implementations, the signature is based on a key derived from a Seed from which one or more keys for facilitating one or more Interactions between a plurality of Entities associated with the Community can be derived.

The method 1300 further comprises, at block 1304, checking a proof indicative that the new or existing Entity applied the signature.

The method 1300 may be considered to be interrelated to the methods 1100 and 1200, and therefore facilitates or enables similar or related functionality as described in relation to the methods 1100 and/or 1200. The embodiments described in relation to the method 1100 and/or 1200 may, where appropriate, be combined with, form part of, or be used in conjunction with the method 1300 and/or its related embodiments.

In some embodiments, the signature is verified using a public key associated with a Handle associated with the new or existing Entity.

In some embodiments, the method 1300 further comprises checking a present status of the new or existing member. For example, this check may indicate if the member is no longer endorsed or no longer has a status to allow them to perform certain Interactions in association with the Community.

In some embodiments, the method 1300 comprises endorsing the new or existing Entity on an Interaction or Workflow in response to successful verification and checking; or in response to detecting that the new or existing Entity has a different authorization level to that indicated by the signature or present status, providing an update regarding the different authorization level to the community.

In some cases, the different authorization level may include that the member is endorsed by a certain number of community members, but then one of those members might revoke their endorsement, which might affect the access to a project enabled by the specified authorization level.

In some cases, the update may be provided to one or more other Entities associated with the Community.

FIG. 14 is a flowchart of a method 1400 according to an aspect. The method 1400 is implemented by a computing device. Examples of such a computing device are described below. The method 1400 may be combined with, implemented as part of, or be used in conjunction with techniques that apply to the physical realm such as depicted by FIG. 5. For example, the computing device may be part of the OS platform 502.

The method 1400 comprises, at block 1402, receiving an indication that a share of a public key associated with an Entity is not accessible and/or has been destroyed. In some cases, the indication may be received from a computing node 506 that has been potentially compromised and/or another computing node 506 that is aware that the computing device 506 has been potentially compromised.

The method 1400 further comprises, at block 1404, indicating that the Entity is potentially compromised.

The method 1400 may be considered to be interrelated to the methods 1100, 1200, and 1300, and therefore facilitates or enables similar or related functionality as described in relation to the methods 1100, 1200, and/or 1300. The embodiments described in relation to the method 1100, 1200, and/or 1300 may, where appropriate, be combined with, form part of, or be used in conjunction with the method 1400 and/or its related embodiments.

The method 1400 and related techniques and embodiments may address one or more issues related to supply chain fraud by providing a mechanism to secure and trace assets. The method 1400 and related techniques and embodiments may form part of a platform to globally authenticate and track assets with a proprietary owner-centric model and secure supply chain features to curb financial crime. An example of such a platform is depicted by FIG. 5. The solution may provide robust supply chain management accessible to Entities to reduce supply chain fraud, enhance efficiency and proactive risk management, strengthen supply chain integrity, and/or identify fraudulent activity.

One or more of the techniques, aspects, or embodiments described herein may secure an Entity's Origin, pair this with authenticated Entities (e.g., clients/partners) and ensure that identification mechanisms (e.g., based on RFID tags) are traceable to verify an Entity's location at any time. The cryptographically secure entity may be traceable with real-time ML analytics, thereby delivering a unified solution for supply chain asset tracking that ensures assets remain untampered. Such an approach may offer businesses security and proactive risk management tools, specialized supply chain integrity, and actionable insights to elevate operational efficiency and fraud prevention.

In an example, the Entity may comprise a physical Entity (e.g., an asset in the real world). Thus, if the physical Entity is compromised, the indication provided at block 904 may be communicated to any other relevant Entities such that appropriate action can be taken, such as revocation of the status of the potentially compromised Entity.

In some embodiments, the computing device is configured to implement a threshold signature scheme whereby an aggregate public key is generated, and a share of the aggregate public key is assigned to a check device of one or more check devices associated with the Entity (e.g., physical Asset).

In some embodiments, a threshold number of the shares is needed to verify that the Entity has not been compromised, and wherein if the threshold number of the shares is not received by the computing device, the computing device indicates that the Entity is potentially compromised.

In some embodiments, the check device comprises a breakable seal for attaching to or otherwise associating with the physical Entity, and wherein breaking the seal causes destruction of or restricts access to the share of the public key and/or a payload assigned to the check device. Thus, once the seal is broken, the share of the public key is not obtainable from the physical Entity. Without the share of the public key being obtainable, it can be determined that the status of the physical Entity should be changed (e.g., revoked). In other similar words, without the share of the public key, it is not possible to verify the integrity of the physical Entity, thereby implying that the physical Entity is compromised.

FIG. 15 is a flowchart of a method 1500 according to an aspect. The method 1000 is implemented by a computing device associated with an Entity. Examples of such a computing device are described below.

The method 1500 comprises, at block 1502, controlling an Interaction between a controlled Entity under control of the Entity and another Entity.

The method 1500 may be considered to be interrelated to the methods 1100, 1200, 1300 and 1400, and therefore facilitates or enables similar or related functionality as described in relation to the methods 1100, 1200, 1300, and/or 1400. The embodiments described in relation to the method 1100, 1200, 1300, and/or 1400 may, where appropriate, be combined with, form part of, or be used in conjunction with the method 1500 and/or its related embodiments.

In some embodiments, the Entity specifies a defined right of Interaction for the other Entity to interact with the controlled Entity.

In some embodiments, the defined right of Interaction comprises a right to one or more of: access; view; exploit; change; develop; and/or share the controlled Entity in part or in whole.

In some embodiments, the method 1500 comprises performing an Interaction that comprises sharing the controlled Entity in part or in whole with one or more other Entities.

In some embodiments, the other Entity is permitted to perform an Interaction comprising sharing another controlled Entity in part or in whole with one or more other Entities.

In some embodiments, the method 1500 comprises the method of any one of the other techniques, aspects, or embodiments described herein.

FIG. 16 is a flowchart of a method 1600 according to an aspect. The method 1600 is implemented by a computing device associated with an Entity. Examples of such a computing device are described below.

The method 1600 comprises, at block 1602, obtaining a key associated with a Community. The key is configured to facilitate one or more Interactions between the Entity and one or more other Entities associated with the Community. In some implementations, obtaining the key comprises deriving the key (which may be referred to as an Interaction key) from a Seed as described according to certain techniques of this disclosure.

The method 1600 may be considered to be interrelated to the methods 1100, 1200, 1300, 1400 and 1500, and therefore facilitates or enables similar or related functionality as described in relation to the methods 1100, 1200, 1300, 1400, and/or 1600. The embodiments described in relation to the method 1100, 1200, 1300, 1400, and/or 1500 may, where appropriate, be combined with, form part of, or be used in conjunction with the method 1600 and/or its related embodiments.

In some embodiments, the one or more Interactions facilitate one or more of: (i) project creation and/or management; (ii) Handle management; (iii) community proof; (iv) issuance proof; (v) cryptocurrency account management; (vi) digital asset management.

In some embodiments, the obtained key is dedicated for use in connection with only one Interaction of the one or more Interactions such that a different key is to be obtained for a subsequent or different type of Interaction.

In some embodiments, the method comprises performing one or more Interactions as part of or in conjunction with the one or more other Entities.

In some embodiments, the method comprises receiving a message signed by another Entity as part of a Workflow that requires the Entity and the other Entity to sign a message, wherein the respective signatures applied by the Entity and the other Entity are derived from an access method configured for the respective Entity and other Entity.

In some embodiments, the method comprises transmitting a message signed by the Entity as part of a Workflow that requires the Entity and another Entity to sign a message, wherein the respective signatures applied by the Entity and the other Entity are derived from an access method configured for the respective Entity and other Entity.

In some embodiments, the access method is based on one or more of: a Web3 based wallet; a Multi Factor Authentication (MFA) process; future authentication methods including one or more of: future web X wallets, physical devices, biometric scanning, or digital identity providers/wallets; an Alias associated with the Entity; a temporary key issued by a trusted Entity.

In some embodiments, the Community is associated with a controlled Entity comprising one or more of: user information; a digital file; a digital asset; a watermark or fingerprint representative of a physical item or digital data; a biometric marker; a physical item represented by digital data; an electronic computer including one or more of: a central processing unit (CPU); bootloader or other trusted platform; a token; an Non-Fungible Token (NFT); a Semi-Fungible Token (SFT); code; a smart contract; training data for an AI; an AI model; any other concept that can be represented in digital form.

In some embodiments, the method further comprises requesting to join an Interaction or Workflow associated with the Community, wherein Entity and another Entity associated with the Community is to sign one or more messages to facilitate the Entity joining the Interaction or Workflow.

In some embodiments, the method comprises receiving a request by another Entity to join an Interaction or Workflow associated with the Community, wherein Entity and the other Entity is to sign one or more messages to facilitate the other Entity joining the Interaction or Workflow.

In some embodiments where the Entity has joined the Interaction or Workflow, the method further comprises: obtaining a request to allocate one or more Interactions, Workflows, and/or proposals to one or more Entities associated with the Community. In response to a specified number of Entities associated with the Community approving the allocation, the method may further comprise signing the request to prove and/or endorse the allocation of the one or more Interactions, Workflows, and/or proposals.

In some embodiments, where the Entity has joined the Interaction or Workflow, the method comprises: defining an Interaction or Workflow; selecting an Entity type; creating the Interaction or Workflow based on the selected Entity type

In some embodiments, the method comprises associating one or more Entities with the Community and endorsing each Entity for a role as part of the Interaction or Workflow.

In some embodiments, the key is configured to provide a second Entity, of the one or more other Entities, with a specified right to interact in part or in whole with one or more other Entities associated with the Community.

In some embodiments, the specified right to interact in part or in whole with one or more other Entities associated with the Community comprises one or more of: an Interaction that requires no access to a third Entity; or an Interaction that allows the second Entity to: access, view, exploit, change, develop, and/or share the third Entity in part or in whole.

In some embodiments, the method 1600 comprises the method of any one of the other techniques, aspects, or embodiments described herein.

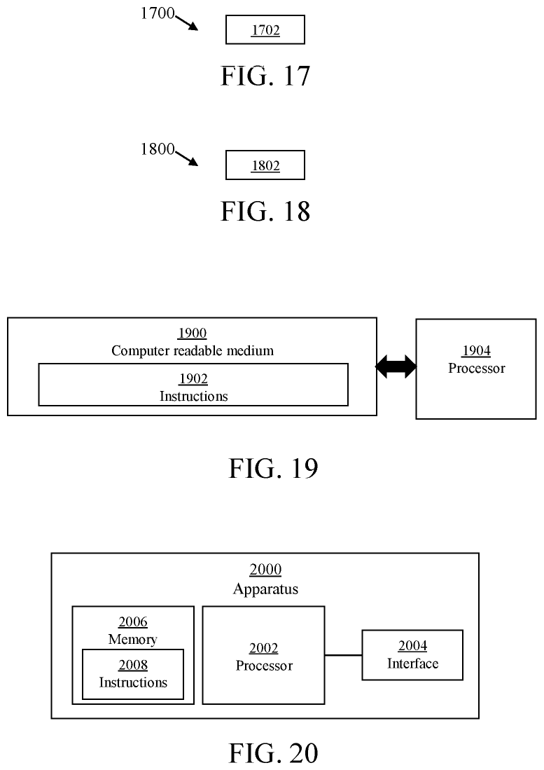

FIG. 17 is a flowchart of a method 1700 according to an aspect. The method 1700 is implemented by a computing device associated with an Entity. Examples of such a computing device are described below.

The method 1700 comprises, at block 1702, generating a signature for data. The signature is combinable with one or more other signatures generated by one or more other Entities.

The method 1700 may be considered to be interrelated to the methods 1100, 1200, 1300, 1400, 1500 and 1600, and therefore facilitates or enables similar or related functionality as described in relation to the methods 1100, 1200, 1300, 1400, 1500, and/or 1600. The embodiments described in relation to the method 1100, 1200, 1300, 1400, 1500, and/or 1600 may, where appropriate, be combined with, form part of, or be used in conjunction with the method 1700 and/or its related embodiments.

In some embodiments, the signature generated by the Entity, when combined with the one or more other signatures generated by the one or more other Entities, represents a combined signature forming a proof that the Entity and the one or more other Entities signed the data.

In some embodiments, the Entity and the one or more other Entities are associated with a Community.

In some embodiments, the data comprises one or more of: information identifying the Entity and/or the one or more other Entities; one or more timestamps indicative of a time of signing by the one or more other Entities; a public key associated with one or more private keys used by the Entity and/or one or more other Entities to sign the data; information on how to access the public key; at least part of one or more signatures generated by the one or more other Entities; information on how to access the one or more signatures; and/or any other metadata.

In some embodiments, the data represents or is used as part of an Interaction. For example, the data may comprise one or more statements (e.g., comprising one or more data entities) as described above. Such data may then be interacted with.

In some embodiments, the Interaction represents an endorsement. For example, the data may be endorsed.

In some embodiments, the method 1700 comprises: receiving the data; deriving a key; and generating the signature based on the key.

In some embodiments, the key is a contextual key generated by the Entity. The contextual key is signed by the Entity.

In some embodiments, the contextual key is signed based on an Origin associated with the Entity.

FIG. 18 is a flowchart of a method 1800 according to an aspect. The method 1800 is implemented by a computing device associated with an Entity. Examples of such a computing device are described below.

The method 1800 comprises, at block 1802, verifying a combined signature generated based on data signed by the Entity and one or more other Entities. The signature generated by the Entity is combinable with one or more other signatures generated by one or more other Entities.

The method 1800 may be considered to be interrelated to the methods 1100, 1200, 1300, 1400, 1500, 1600, and 1700, and therefore facilitates or enables similar or related functionality as described in relation to the methods 1100, 1200, 1300, 1400, 1500, 1600, and/or 1700. The embodiments described in relation to the method 1100, 1200, 1300, 1400, 1500, 1600, and/or 1700 may, where appropriate, be combined with, form part of, or be used in conjunction with the method 1800 and/or its related embodiments.

In some embodiments, the method 1800 comprises: accessing the combined signature; and performing verification based on a public key associated with the Entity and the one or more other Entities.

In aspects of the disclosure, a computing device or computing node is configured to implement one or more of the techniques, aspects, or embodiments described herein.

In some cases, the computing device or computing node comprises: a memory; and a processor coupled to the memory. The processor is configured to implement any one of techniques, aspects, or embodiments described herein.

In aspects of the disclosure, an apparatus is provided. The apparatus comprises means (such as one or more processors) for performing any one of techniques, aspects, or embodiments described herein.

In aspects of the disclosure, a non-transitory machine-readable medium stores instructions which, when implemented by a processor, cause the processor to implement any one of the techniques, aspects, or embodiments described herein.

In aspects of the disclosure, a computer-readable (storage) medium stores instructions which, when implemented by a processor, cause the processor to implement any one of the techniques, aspects, or embodiments described herein.

Any reference to ‘a’processor includes ‘one or more’processors.

Some applications that are enabled by one or more concepts described herein are now described.

One or more embodiments described may have utility in one or more of the following applications, personal or business functions and industries: Insurance. Serving Legal Judgment. Additional Lock for Escrow to Stop Theft. Digital Inheritance. Wrapped Physical Assets. Facilitate Personalized Data Management. Creating Value within Content. Loyalty. Ticketing, Events & Proof of Attendance. Working Offline. Social Account Fraud. Pensions. Mortgages. Social Media such as for personal networking and business networking. Cross Border Sovereignty and ID Verification Regulated Artificial Intelligence (AI)-ID for AI. Passwords. Live Data Analytics. Certificates. Auditing & Audits. Energy Grids & Power Plants. Shipping. Oil and Gas. Airlines. Anti Money Laundering (AML) Regulations. Know Your Customer (KYC) Verification. Physical Item Security. Medical Counterfeiting Security. Transport and Ticketing. Software Development Kit (SDK) for Developers. Non-Fungible Token (NFT) Marketplace. Recruitment. Energy and Utilities & Carbon Credits. Credit Scoring. Mobile Crypto Apps. Incubators & Memberships. Software, gaming and metaverse. Ratings and Reviews. Proof of Ownership—trust-less, zero knowledge. Social Scoring. Government departments and ministries. Intellectual Property. Proof of Authorship (e.g., documents/software/music). Plagiarism Checker. Animal Chipping & Pets. AI/Machine Learning. Training Videos. Crowdfunding. Event Completion & Endorsement. Witness Pool for Endorsements—Random selection to verify a witness. Right to Work in a country. Regional Travel Rules. Data Protection and Privacy Regulation. System and Organization Controls Attestation. Event Management—Conferences & Exhibitions Advertising, Advertisers. Sponsorship. Banking. Legal Entity Identifier (LEI). White Papers (Policy Proposals for Future Legislation). Biotechnology. Broadcasting. Chemicals. Clothing and Apparel. Computers and Electronics. Risk Assessments. Agency Endorsements. Education. Engineering and Fabrication. Financial Services. Food Service Industry. Government Agencies. Health Care Organizations, Government Healthcare Organizations and International Healthcare Organizations. IT Solutions & Software Providers. Non-profit Organizations & Charities. Online Payment Systems. Pharmaceuticals. Production Companies. Public Relations. Real Estate. Security & Surveillance. Business Schools. Data Analytics. Wearable Devices. Web Servers and Mail. Social Media Platforms. Decentralized Autonomous Organizations (DAO) & Payments. Transportation Companies. Travel & Tourism. Travel Reward Schemes. Venture Capitalists. Robotics. Video Games and Consoles. Data Storage. Biometrics. Wine Distributors. Printing and Printers. Automated Teller Machines (ATMs). Warehousing. Augmented Reality (AR). Virtual Reality (VR). Trading Platforms. Shipping Companies & Freight Logistics. Search Engines. Podcasts and Radio Stations. Media Publishers. Museums. Film Production. Hotels. Luxury Goods. Delivery Services. Healthcare Facilities and Hospitals. Emergency Aid—Red Cross. Back Door Hires. AI Entity Profiles & Automation. Data Modeling with AI. Dating Apps. Peer-to-Peer (P2P) Selling, Swapping and Buying. Browser Plug-in.

By way of example, one or more aspects or embodiments described herein may have utility in one or more of the following cases studies.

In a recruitment/collaboration scenario, it is possible to use one or more embodiments described herein to facilitate zero-knowledge proof that a person has worked for a certain employer without indicating their personal identity. This may have utility in government departments such as defense, secret services, home office, foreign office, etc., where there may be sensitivity about sharing PII about certain employees when undertaking new work (e.g., with another department or organization), working on projects with new or existing colleagues. Information such as rank, experience, capability of the person can be shared with the colleagues, ministers, etc., without revealing the actual identity of the person. In this manner, such people can be integrated into departments, organizations or projects easily without any concerns over releasing sensitive PII that could otherwise be intercepted.

In legal proceedings, it is possible to serve proceedings or judgment. For example, it is possible to secure the return of fraudulently obtained crypto assets such as Bitcoin (BTC). In some cases, it is possible to serve notice of proceedings or serve judgment by air-dropping an NFT on to the blockchain. Since digital assets can be transferred with a button click, transferring digital assets (which may represent ownership of real assets such as financial or physical assets) is relatively easy. The ease of use and distributed nature of the infrastructure may facilitate certain types of fraudulent and malicious activity. In the case of a digital wallet associated with fraudulent activity, it has been demonstrated that summary judgment can be served to the wallet linking all associated Entities, to facilitate recovery of assets. One or more embodiments described herein may facilitate verification of all Entities whilst creating a smart contract that is able to deliver court documents to a specified wallet. An NFT's smart contract links the Entities such as legal professionals, the courts and government departments. Once the NFT has been viewed, this is tracked and thereby confirm delivery of the documents. Once delivered, a link to a Smart Contract (SC) is prepared to enable the owner of the digital wallet to sign and facilitate automatic redistribution of the assets. If the recipient does not comply, papers can be served, and a recovery process facilitated to force asset recovery via the blockchain or wallet creator.

In an inheritance scenario, a person may have a wide and varied portfolio of accounts, assets and investments with lots of usernames and passwords. In the event of passing away unexpectedly, it is difficult for beneficiaries to know about the entire portfolio of the deceased person. An executor may have difficulty executing the exact wishes of the deceased. One or more embodiments described herein may allow a client to keep an up-to-date digital record of physical and non-physical assets. Beneficiaries can then receive everything as instructed. Execution of the relevant digital contract automatically ensures that assets are distributed correctly, on time and as desired. One or more embodiments described herein may facilitate several possibilities, including presenting a death certificate or proof of life checks that notify beneficiaries if you do not respond to one or more requests for an update. Accordingly, client wishes may be executed, and assets may be digitally assigned to the beneficiaries along with proof of ownership to the beneficiaries.

In a scenario, a client may wish to take their physical assets and create a digital contract that may or may not include benefits including one or more of dividends, collateral and letters of credit, etc. Presently, this involves a legal process involving lots of fees and escrow accounts. One or more embodiments described herein may facilitate wrapping physical assets into an NFT and/or other digital assets. This approach may allow the wrapped asset to be used in a number of ways such as distribution of dividends, collateral, letters of credit and short selling. Such an approach may be designed to be anonymous. The (multiple) signature process described herein may keep the assets safe and reduce associated fees.

In a scenario, it may be possible to insure against loss or theft of crypto assets and facilitate recovery. Crypto fraud is a significant problem and trying to retrieve stolen cryptocurrency may be prohibitively costly and difficult. One or more embodiments described herein may use a combination of the transaction hash, public wallet address and an NFT to form or be represented by a smart contract endorsed by multiple parties. The data may be stored directly in the metadata or another wrapper contract. All parties are notified in case of any unauthorized transfer attempt. Developers may have a link to an API implementing one or more embodiments described herein in order to generate front end solutions. Insurance providers may underwrite assets via signed contracts. Any fraudulent digital assets such as NFTs may be revoked by re-issuing the minted asset and marking illegal transactions as fraudulent on the blockchain, undermining the value of the stolen asset.

In a scenario, a Decentralized Finance (DEFI) crypto project may be targeted to remove targets from a hot wallet and sold on exchanges. One or more embodiments described herein may allow users to set restrictions and signing processes to verify transactions via pre-assigned conditions and multiple approvers to move funds. If there is a breach of these conditions, Endorsements can be revoked. Token provider organizations (and any other connected organizations) may make use of one or more embodiments described herein to ensure that a subset of or all stakeholders within an organization have Handles (e.g., Origin Handles). Such individual Handles combined with an organization Handle may set the relevant conditions to lock or unlock access to move funds from an account.

In a scenario, digital advertisements may be tracked for real life engagement and Interaction. By connecting a Handle (e.g., an Origin Handle) in accordance with one or more embodiments described herein to browser wallets and addresses, privacy and security may be improved. Privacy and security concerns are significant when carrying out digital advertisement tracking. Thus, by reducing or avoiding the release of PII, user privacy is maintained while still facilitating the advertisement tracking for evaluation. Such a solution may link users, creators and advertisers to collaborate and approve key website activity, engagement and purchases by verification of real users.

In a scenario, an NFT worth is established. Digital assets associated with celebrities, sports personalities, brands and sponsors may be valuable and could provide new revenue streams. One or more embodiments described herein may enable collaboration and Endorsements for digital assets. For example, one or more embodiments described herein may facilitate authenticity, provenance and value. Organizations, teams, players, musicians and other celebrities can issue assets on marketplaces with a split of royalties that can be fairly distributed to digital wallets associated with the Handle (e.g., Origin Handle). Such solutions can be executed in a number of ways. For example, past legends may utilize unseen photos or footage that they own the rights to or create NFTs of rising starts to offset the cost of training and investing in them. Such unique experiences may bring together additional revenue streams, while maintaining or improving privacy and/or security.

Public Profiles—this enables users to refine the information they are automatically happy to share with most people. This saves the need of filling out forms and is a more streamlined than any google forms or edge forms process.

Private Profile—this enables users to allow certain companies/Entities access to private information but places full control with the user. The user can change/revoke these permissions easily from their own admin portal.

Embodiments described herein may facilitate connecting the user's Handle to the wallets that have made 3rd party purchases that offer loyalty programs. Any gained loyalty points will be secured against the Handle, enabling cross-wallet benefits if points are shareable to other wallets (i.e., non transferable tokens)—this gives Origin users the ability to control their points and potentially have multiple wallets for multiple activities (i.e. dedicated wallets for Sports and Music). Origin Secured would partner with Sports teams & associations, Musicians and music labels and anyone offering loyalty programs with significant volume to maximize potential. OS can link users, creators, advertisers, sponsors and rights holders to collaborate on projects that enable them to create and manage secure loyalty programs.

Embodiments described herein may facilitate verifying if a Handle has been approved by a KYC verifier. This means any ticketing platform can stipulate and authorize specific user types to purchase tickets—this will eliminate bots from purchasing if the platform uses OS. A service provider may partner with ticketing platforms with significant volume to maximize potential. OS will issue an identity approval process to each Origin Handle to be signed by the parties required to verify the identity of users and protect the platform from fraudulent activity.

Embodiments described herein may facilitate verifying if an Origin Handle has been approved by a KYC verifier. This means any individual can be issued a non-transferable proof of attendance (POA) NFT to their wallet—this enables attendees to mint event photos, videos or other digital assets as NFTs in association with rights holders to sell on marketplaces. This may allow partnering with event organizers and venues with significant volume to maximize potential. OS will allow the identity-approved Origin Handle ticket holders to mint their own non-transferable POA NFT token for each event attended—this enables true loyalty points to be assigned to the real fans who attended.

Embodiments described herein may facilitate a Handle being assigned to a wallet on a personal device, the user can store information related to the Handle that can then be linked to a device connected to the internet. The user can share a QR code (such as a ticket to an event) and the QR pairing will decrypt the associated information to confirm the identity of the user once scanned. Given that some events have issues with connectivity, especially festivals, event organizers need to ensure the solution works offline. One of the biggest advantages that paper-based tickets have is their ability to work without the internet—having a technology that solves these issues means OS can also reverse the process with a user's physical ID to verify being linked to an Origin Handle.

FIG. 19 is a schematic drawing of a computer-readable medium 1900 (e.g., a computer-readable storage medium and/or a non-transitory machine-readable medium) for implementing various embodiments described herein. As used herein, the term “non-transitory” does not encompass transitory propagating signals. The computer-readable medium 1900 stores instructions 1902 readable and executable by a processor 1904 to implement the method of any of the techniques, aspects, or embodiments described herein. The computer-readable medium 1900 and/or the processor 1904 may be implemented by any relevant computing device of the architecture or system described herein.

FIG. 20 is a schematic drawing of apparatus 2000 for implementing various embodiments described herein. The apparatus 2000 may be implemented by any relevant computing device of the architecture or system described herein.

The apparatus 2000 comprises a processor 2002. In some cases, the processor 2002 is configured to communicate with an interface 2004. The interface 2004 may be any interface (wireless or wired) implementing a communications protocol to facilitate exchange of data (e.g., data related to implementing a functionality described herein) with other devices such as another part of the architecture or system described herein.

The apparatus 2000 further comprises a memory 2006 (e.g., non-transitory or otherwise) storing instructions 2008 readable and executable by the processor 2002 to implement various embodiments described herein.

Any of the models described herein may be implemented by the processing circuitry for implementing the methods described herein. Thus, certain blocks of the methods may involve use of such models in order to provide the stated functionality. The models may be (machine learning/artificial intelligence) ML/AI-based or non-ML/AI-based.

While the disclosure has been illustrated and described in detail in the drawings and foregoing description, such illustration and description are to be considered illustrative or exemplary and not restrictive; the invention is not limited to the disclosed embodiments.

One or more features described in one embodiment may be combined with or replace features described in another embodiment.

Embodiments in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, flash storage, etc.) having computer readable program codes therein or thereon.

The present disclosure is described with reference to flow charts and block diagrams of the method, devices, and systems according to embodiments of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine-readable instructions.

The machine-readable instructions may, for example, be executed by a general-purpose computer, a special purpose computer, an embedded processor, or processors of other programmable data processing devices to realize the functions described in the description and diagrams. In particular, a processor or processing circuitry, or a module thereof, may execute the machine-readable instructions. Thus, functional modules of apparatus and other devices described herein may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer, or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the embodiments of the present disclosure.

Elements or steps described in relation to one embodiment may be combined with or replaced by elements or steps described in relation to another embodiment. Other variations to the disclosed embodiments can be understood and effected by those skilled in the art in practicing the disclosure, from a study of the drawings, the disclosure, and the appended embodiments. In the embodiments, the word “comprising” does not exclude other elements or steps, and the indefinite article “a” or “an” does not exclude a plurality. A single processor or other unit may fulfil the functions of several items recited in the embodiments. The mere fact that certain measures are recited in mutually different dependent embodiments does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the embodiments should not be construed as limiting the scope of the disclosure.

The disclosure includes the following subject matter according to the following numbered embodiments.

1. A method implemented by a computing device associated with a user, the method comprising:
generating a Seed;
splitting the Seed into multiple shares;
transmitting a first share of the Seed to a first storage, wherein the first share is encrypted with a first key associated with a Community.

2. The method of embodiment 1, further comprising: transmitting a second share of the Seed to a second storage, wherein the second share is encrypted with a second key associated with the Community.

3. The method of embodiment 2, wherein the second storage is isolated from the first storage.

4. The method of any one of embodiments 2-3, wherein the second key is different to the first key.

5. The method of any one of embodiments 1-4, wherein the Seed is generated from a mnemonic.

6. The method of embodiment 5, wherein the mnemonic is specified by the user or supplied to the user.

7. The method of any one of embodiments 1-6, wherein the Seed is split into multiple shares using a secret sharing protocol.

8. The method of any one of embodiments 1-7, wherein the Seed is useable to deterministically derive one or more cryptographic keys for use in one or more operations.

9. The method of embodiment 8, wherein the one or more operations include one or more of:
(i) an Endorsement operation;
(ii) an aggregate proof operation;
(iii) a blockchain operation;
(iv) a threshold proof operation.

10. The method of any one of embodiments 8-9, wherein the one or more operations facilitate one or more of:
(i) project creation and/or management;
(ii) Handle management;
(iii) community proof;
(iv) issuance proof;
(v) cryptocurrency account management;
(vi) digital asset management.

11. The method of any one of embodiments 8-10, wherein the derived one or more cryptographic keys comprises one or both of a private key and a public key of a key pair.

12. The method of any one of embodiments 8-11, wherein the derived one or more cryptographic keys are single use for an operation such that a new one or more cryptographic keys is to be derived for a subsequent operation.

13. The method of embodiment 12, wherein the operation has a different context to the subsequent operation.

14. The method of any one of embodiments 8-13, comprising:
deriving a first private key for a first operation; and
using the first private key to sign data associated with the first operation.

15. The method of embodiment 14, comprising:
deriving a second private key for a second operation; and
using the second private key to sign data associated with the second operation.

16. The method of any one of embodiments 1-15, comprising:
deriving an indication of proof of identity of the user.

17. The method of embodiment 16, wherein the indication of proof of identity comprises one or more of:
a Handle associated with the user, contextual metadata and assertions; and
a proof key derived from the Seed with a cryptographic proof of the provenance of that key.

18. The method of any one of embodiments 16-17, comprising:
transmitting the indication to one or more Community endorsers.

19. The method of embodiment 18, comprising:
in response to being endorsed by the one or more of the Community endorsers, receiving an indication that the user/Entity has joined a Community comprising the one or more Community endorsers.

20. The method of embodiment 19, wherein the indication is indicative of a community proof that the user/Entity belongs to the Community.

21 The method of any one of embodiments 19-20, comprising performing one or more operations as part of or in conjunction with one or more members of the Community.

22. The method of any one of embodiments 1-21, comprising:
receiving a proof key indicative of a request by a new member to join a Community comprising the user; and
in response to the user authorizing the request, signing the proof key with an endorsement key derived from the Seed.

23. The method of any one of embodiments 1-22, comprising:
receiving one or more signed proof keys associated with a request by a new member to join a Community comprising the user; and
generating a new community proof indicative of the new member being endorsed by one or more existing Community members; or
generating a revised community proof indicative of an existing member being endorsed by one or more additional existing Community members.

24. The method of any one of embodiments 16-23, wherein the indication of proof includes a public key associated with the indication, to facilitate verification of the indication.

25 The method of any one of embodiments 1-24, wherein the user is a single point of authority.

26. The method of any one of embodiments 1-25, comprising obtaining a Handle associated with the user.

27. The method of embodiment 26, wherein the Handle identifies the multiple shares of the Seed.

28. The method of any one of embodiments 26-27, wherein the Handle identifies information about an Endorsement.

29. The method of any one of embodiments 26-28, wherein the Handle comprises a front end visible to the user and a back end comprising information to facilitate reconstruction of the Seed.

30. The method of any one of embodiments 26-29, wherein the Handle is endorsed by a Community comprising the user.

31. The method of embodiment 30, wherein the Community comprises one or more endorsers, wherein each endorser has its own unique Handle and associated Seed, and wherein one or more of the endorsers combine to create an aggregate signature to act as an initial proving signature for the Handle associated with the user.

32. The method of any one of embodiments 1-31, comprising:
obtaining an indication of a commitment;
signing the indication with a private key derived from the Seed; and
transmitting the signed indication.

33. The method of embodiment 32, wherein the indication of the commitment comprises a nonce and approval information.

34. The method of any one of embodiments 32-33, wherein the indication of the commitment is obtained from a serving module, and wherein the signed indication is transmitted to the serving module or another serving module.

35. The method of embodiment 34, wherein the serving module is configured to produce one or more signatures and/or proof to be applied to endorse an Entity in response to determining that one or more specified members of a Community have signed their indication and transmitted the signed indication to the serving module.

36. The method of any one of embodiments 1-35, comprising:
retrieving a message from a serving module;
signing the message with a private key derived from the Seed;
transmitting a package comprising the signed message to the serving module and/or another serving module.

37. The method of embodiment 36, wherein the package further comprises one or more of: a public key derived from the Seed; an indication of proof; and witness information.

38. The method of embodiment 37, wherein the indication of proof does not include a private key.

39. The method of any one of embodiments 37-38, wherein the indication of proof is for implementing a zero-knowledge proof.

40. The method of any one of embodiments 1-39, comprising:
verifying a signature associated with an Entity using a public key associated with the Entity.

41. The method of any one of embodiments 1-40, wherein the user is a new or soon-to-be new member of a Community, the method comprising:
receiving a package comprising a message signed by an existing member of the Community, wherein the package is indicative that the existing member endorses the new or soon-to-be new member of the Community.

42. The method of embodiment 41, wherein the package further comprises one or more of: a public key derived from a Seed of the existing member; an indication of proof; and witness information.

43. The method of any one of embodiments 41-42, comprising:
using the received package to attest that the user is part of the Community.

44. The method of any one of embodiments 1-43, comprising:
signing data using a private key deterministically derived from the Seed.

45. The method of embodiment 44, wherein a Handle associated with the private key is contained with signature metadata.

46. The method of any one of embodiments 1-45, comprising:
obtaining signature metadata; and
verifying that the signature was produced by a specified Entity by checking the specified Entity's key issuance proof against an issuance key associated with the specified Entity.

47. The method of embodiment 46, wherein a Handle associated with the specified Entity's key is within the signature metadata.

48. The method of embodiment 47, wherein a public key related to the Handle is also within the signature metadata.

49. The method of any one of embodiments 1-48, comprising:
endorsing an Entity to produce an Endorsement, wherein the Endorsement is encrypted and/or requires proof of access to unlock data associated with the user.

50. The method of any one of embodiments 1-49, comprising:
receiving a message signed by another user as part of an approval flow that requires the user and the other user to sign a message, wherein the respective signatures applied by the user and the other user are derived from an access method configured for the respective user and other user.

51. The method of any one of embodiments 1-50, comprising:
transmitting a message signed by the user as part of an approval flow that requires the user and another user to sign a message, wherein the respective signatures applied by the user and the other user are derived from an access method configured for the respective user and other user.

52. The method of any one of embodiments 50-51, wherein the message signed by the user is different to the message signer by the other user.

53. The method of any one of embodiments 50-52, wherein the access method is based on one or more of:
a Web3 based wallet that has been associated with a Handle associated with the respective user;
a Multi Factor Authentication (MFA) process used to reconstruct a signature via a key derivation function;
an issued Application Programming Interface (API) key and a key derivation function; future authentication methods such as future web X wallets, physical devices, biometric scanning, or digital identity providers/wallets.

54. The method of any one of embodiments 50-53, wherein the access method is used as an authorization to allow a Handle to be unlocked and used for one or more of: key issuance; proof; and Endorsement.

55. The method of any one of embodiments 1-4, comprising:
causing an Endorsement of an Entity to be revoked.

56. The method of embodiment 55, wherein revocation of the Endorsement causes a new revision of an Endorsement to be issued for the Entity, and wherein metadata associated with the revised Endorsement is updated to reflect that the user no longer endorses the Entity.

57. The method of any one of embodiments 1-56, comprising:
using a private key deterministically derived from the Seed to sign one or more of: metadata and a commitment associated with an asset.

58. The method of embodiment 57, wherein the asset comprises one or more of:
user information;
a digital file;
a digital asset;
A watermark or fingerprint (e.g., for physical or digital);
A biometric marker;
A physical item;
Electronic computer (central processing unit (cpu) or bootloader or other trusted platform);
a token;
an NFT;
an SFT;
code;
a smart contract;
training data for an AI;
an AI model.

59. The method of any one of embodiments 1-58, comprising:
requesting to join a project associated with a Community, wherein user and another user in the Community signs one or more messages to facilitate the user joining the project.

60. The method of any one of embodiments 1-59, comprising:

receiving a request by another user to join a project associated with a Community comprising the user, wherein user and the other user signs one or more messages to facilitate the other user joining the project.

61. The method of any one of embodiments 59-60, wherein the user has joined the project, the method comprising:

obtaining a request to allocate one or more Workflows and/or proposals associated with the project to one or more members of the Community;

in response to a specified number of the members of the Community approving the allocation, signing the request to prove and endorse the allocation of the one or more Workflows and/or proposals.

62. The method of any one of embodiments 59-61, wherein the user has joined the project, the method comprising:
defining a project;
selecting an asset type;
creating the project based on the selected asset type;
optionally, adding one or more users to the Community and endorsing each user for each role in the project for each collaborator.

63. The method of embodiment 62, wherein creating the project comprises minting one or more tokens on a blockchain and/or minting a representation of the Origin Handles on the blockchain.

64. The method of any one of embodiments 1-63, comprising:
requesting data associated with another user or Entity, wherein the user or Entity is a point of authority for that data;
in response to the request being approved by the user or Entity, receiving the data.

65. The method of embodiment 64, wherein a Handle associated with the user or Entity is configured to approve the request based on criteria specified by the user or Entity, and wherein the user or Entity is configured to obtain the data and transmit the data to the requesting user.

66. The method of any one of embodiments 64-65, wherein the data is no longer sharable by the user or Entity after completion of the transaction.

67. The method of any one of embodiments 1-66, comprising:
receiving a commitment, wherein the commitment comprises one or more hashes of unique identifiers associated with the user.

68. The method of embodiment 67, wherein the commitment is associated to one or more of: a Handle being endorsed; a Handle of an endorser; a signature; and key proof.

69. The method of any one of embodiments 1-68, comprising:
storing a share of a public key in a storage of the computing device, wherein one or more other shares of the public key is shared with one or more other computing devices.

70. The method of embodiment 69, wherein the storage is configured to be deleted in response to the computing device being tampered with.

71. The method of any one of embodiments 69-70, wherein the storage is associated with an RFID tag which, when tampered with, prevents access to the share of the public key.

72. The method of any one of embodiments 69-71, comprising:
attaching the computing device to a physical asset to be tracked in such a way that if the physical asset is tampered with or otherwise damaged, the computing device is to prevent access to the share of the public key.

73. A method implemented by a computing node, the method comprising:
receiving a share of a Seed; and
storing the share in a memory accessible to the computing node, wherein the share is encrypted.

74. The method of embodiment 73, wherein the Seed is generated by a computing device associated with a user.

75. The method of any one of embodiments 73-74, comprising:
in response to a request, transmitting the share to facilitate user reconstruction of a Seed and/or a Handle associated with the user.

76. The method of any one of embodiments 73-75, wherein the share is transmitted in encrypted form or decrypted prior to transmission.

77. The method of any one of embodiments 73-76, wherein the computing node is configured to produce one or more signatures and/or proof to be applied to endorse a user and/or an Entity in response to determining that one or more specified members of a Community have signed an indication and transmitted the signed indication to the computing node.

78. A method implemented by a computing device in a Community, the method comprising:
verifying a signature applied to metadata by a new or existing member of the Community; and
checking a proof indicative that the new or existing member of the Community applied the signature.

79. The method of embodiment 78, wherein the signature is verified using a public key associated with a Handle associated with the new or existing member.

80. The method of any one of embodiments 78-79, further comprising checking a present status of the new or existing member.

81. The method of any one of embodiments 78-80, comprising:
endorsing the new or existing member for a project in response to successful verification and checking; or
in response to detecting that the new or existing member has a different authorization level to that indicated by the signature or present status, providing an update regarding the different authorization level to the Community.

82. A method implemented by a computing device, the method comprising:
receiving an indication that a share of a public key associated with a physical asset is not accessible and/or has been destroyed; and
indicating that the physical asset is potentially compromised.

83. The method of embodiment 82, wherein the computing device is configured to implement a threshold signature scheme whereby an aggregate public key is generated, and a share of the aggregate public key is assigned to a check device of one or more check devices associated with the physical asset.

84. The method of any one of embodiments 82-83, wherein a threshold number of the shares is needed to verify that the physical asset has not been compromised, and wherein if the threshold number of the shares is not received by the computing device, the computing device indicates that the physical asset is potentially compromised.

85. The method of any one of embodiments 83-84, when dependent on embodiment 83, wherein the check device comprises a breakable seal for attaching to or otherwise associating with the physical asset, and wherein breaking the seal causes destruction of or restricts access to the share of the public key assigned to the check device.

86. A computing device configured to implement any one of embodiments 1-72.

87. A computing node configured to implement any one of embodiments 73-77.

88. A computing device configured to implement any one of embodiments 78-81.

89. A computing device configured to implement any one of embodiments 82-85.

90. The computing device or computing node of any one of embodiments 86-89, comprising
a processor; and
a memory storing instructions readable and executable by the processor to cause the process to implement any one of the embodiments 1-89.

91. A non-transitory machine-readable medium storing instructions which, when implemented by a processor, cause the processor to implement any one of embodiments 1-89.

### ABBREVIATIONS

the following abbreviations are used in this disclosure.
AI Artificial Intelligence
AML Anti Money Laundering
API Application Programming Interface
AR Augmented Reality
ATM Automated Teller Machine
BLS Boneh-Lynn-Shacham
BTC Bitcoin
CX Customer Experience
DAO Decentralized Autonomous Organizations
DEFI Decentralized Finance
ECIES Elliptic Curve Integrated Encryption Scheme
GUI Graphical User Interface
HD Hierarchical Deterministic
ID Identifier or Identity (depending on context)
JSON JavaScript Object Notation
KDF Key Derivation Function
KYC Know Your Customer
LEI Legal Entity Identifier
MFA Multi Factor Authentication
ML Machine Learning
NFT Non-Fungible Token
OS Origin Standard
P2P Peer-to-Peer
PBKDF Password-Based Key Derivation Function (e.g., 1 and 2)
QR Quick Response
RFID Radio Frequency Identification
SC Smart Contract
SDK Software Development Kit
SFT Semi-Fungible Token
SMS Short Message/Messaging Service
UI User Interface
UX User Experience
VR Virtual Reality

1. A method implemented by a computing device associated with an Entity, the method comprising:
generating a Seed from which one or more keys for facilitating one or more Interactions between the Entity and one or more other Entities associated with a Community can be derived;
splitting the Seed into multiple shares; and
transmitting a first share of the Seed to a first storage, wherein the first share is encrypted with a first key, of the one or more keys, associated with the Community.

2. The method of claim 1, wherein the one or more keys are used to facilitate one or more Endorsements.

3. The method of claim 2, wherein the one or more Endorsements are used to endorse data comprising or derived from one or more Assertions.

4. The method of claim 1, wherein an Interaction key, derived from the Seed, is configured to facilitate an Interaction of the one or more Interactions, and wherein the Interaction key is configured to provide a second Entity associated with the Community with a specified right to interact in part or in whole with one or more other Entities associated with the Community.

5. The method of claim 4, wherein the specified right to interact in part or in whole with another Entity comprises one or more of:
an Interaction that requires no access to a third Entity associated with the Community; or
an Interaction that allows the second Entity to: access, view, exploit, change, develop, and/or share the third Entity in part or in whole, and wherein the Entity is associated with one or more of: an application, an individual, an organization, and/or a community of Communities, wherein the second Entity is associated with one or more of: an application, an individual, an organization, and/or a community of Communities, and wherein the third Entity is associated with an Asset.

6. The method of claim 1, wherein the Entity is to control an Interaction between a controlled Entity under control of the Entity and another Entity associated with the Community.

7. The method of claim 1, further comprising:
transmitting a second share of the Seed to a second storage, wherein the second share is encrypted with a second key, of the one or more keys, associated with the Community.

8. The method of claim 1, wherein the derived one or more keys are single use for an Interaction such that a new key is to be derived based on the Seed for a subsequent or different type of Interaction.

9. The method of claim 1, comprising:
deriving a first private key of the one or more keys for a first Interaction; and
using the first private key to sign data associated with the first Interaction.

10. The method of claim 9, comprising:
deriving a second private key of the one or more keys for a second Interaction; and
using the second private key to sign data associated with the second Interaction.

11. The method of claim 1, comprising:
deriving an indication of proof of identity of the Entity, wherein the indication of proof of identity comprises one or more of:
a Handle associated with the Entity, contextual metadata and assertions; and
a proof key derived from the Seed with a cryptographic proof of the provenance of that key.

12. The method of claim 11, comprising:
transmitting the indication to one or more of the other Entities associated with the Community; and
in response to being endorsed by the one or more of the other Entities associated with the Community, receiving an indication that the Entity can interact with one or more of the other Entities associated with the Community.

13. The method of claim 12, wherein the indication is indicative of a proof that the Entity can interact with the one or more other Entities associated with the Community, the method further comprising performing one or more Interactions as part of or in conjunction with the one or more other Entities.

14. A method implemented by a computing node, the method comprising:
receiving a share of a Seed from which one or more keys for facilitating one or more Interactions between a plurality of Entities associated with a Community can be derived; and
storing the share in a memory accessible to the computing node, wherein the share is encrypted with a first key, of the one or more keys, associated with the Community.

15-153. (canceled)

154. A computing device, comprising
a memory; and
a processor coupled to the memory, the processor configured to implement the method of claim 1.

155. (canceled)

156. A non-transitory machine-readable medium storing instructions which, when implemented by a processor, cause the processor to implement the method of claim 1.

157. (canceled)

158. A computing device, comprising
a memory; and
a processor coupled to the memory, the processor configured to implement the method of claim 14.

159. A non-transitory machine-readable medium storing instructions which, when implemented by a processor, cause the processor to implement the method of claim 14.
